(19) United States
(12) Patent Application Publication
(10) Pub. No.: US 2024/0049092 A1
(43) Pub. Date: Feb. 8, 2024

(54) CELL RESELECTION USING EXPECTED CELL SERVING TIME

(71) Applicant: Telefonaktiebolaget LM Ericsson (PUBL), Stockholm (SE)

(72) Inventors: Helka-Liina Määttänen, ESPOO (FI); Sebastian Euler, STORVRETA (SE); Johan Rune, LIDINGÖ (SE); Emre Yavuz, STOCKHOLM (SE); Jonas Sedin, BRENTFORD Greater London (GB)

(21) Appl. No.: 18/552,473

(22) PCT Filed: Apr. 1, 2022
(86) PCT No.: PCT/IB2022/053082

§ 371 Date: Sep. 26, 2023

Related U.S. Application Data
(60) Provisional application No. 63/169,267, filed on Apr. 1, 2021.

(51) Int. Cl. H04W 36/30

(52) U.S. Cl. CPC H04W 36/30; H04W 84/06

(57) ABSTRACT

According to some embodiments, a method performed by a wireless device for cell selection or reselection in a non-terrestrial network (NTN) comprises determining whether to perform one or more cell selection or reselection measurements based on a cell selection or reselection criteria. The cell selection or reselection criteria is based on a signal quality of a serving cell and a relationship between the wireless device and a satellite or spot beam of the NTN. Upon determining that the cell selection or reselection criteria for performing measurements is satisfied, performing the one or more cell selection or reselection measurements.

### TECHNICAL FIELD

Embodiments of the present disclosure are directed to wireless communications and, more particularly, to cell reselection using expected cell serving time.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

The Third Generation Partnership Project (3GPP) fifth generation (5G) radio access network (RAN) architecture is described in TS 38.401v15.4.0.

FIG. 1 is a block diagram illustrating the 5G RAN architecture. The NG-RAN consists of a set of gNBs connected to the 5G core (5GC) through the NG interface. A gNB may support frequency division duplex (FDD) mode, time division duplex (TDD) mode or dual mode operation. One or more gNBs may be interconnected through the Xn interface. A gNB may consist of a gNB central unit (gNB-CU) and gNB distributed units (gNB-DUs). A gNB-CU and a gNB-DU are connected via an F1 logical interface. One gNB-DU is connected to only one gNB-CU. For resiliency, a gNB -DU may be connected to multiple gNB-CU by appropriate implementation. NG, Xn and F1 are logical interfaces.

The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

A gNB may also be connected to a long term evolution (LTE) eNB via the X2 interface. Another architectural option is that where an LTE eNB connected to the Evolved Packet Core (EPC) network is connected over the X2 interface with a nr-gNB, then the latter is a gNB not connected directly to a CN and connected via X2 to an eNB for the sole purpose of performing dual connectivity.

The architecture illustrated in FIG. 1 may be expanded by splitting the gNB-CU into two entities. A gNB-CU user plane (gNB-CU-UP), which serves the user plane and hosts the Packet Data Convergence Protocol (PDCP) and a gNB-CU control plane (gNB-CU-CP), which serves the control plane and hosts the PDCP and radio resource control (RRC) protocol. A gNB-DU hosts the radio link control (RLC), medium access control (MAC), and physical layer (PHY) protocols.

Cell selection is the process performed by a user equipment (UE) for selecting a cell to camp on when the UE does not already camp on a cell. Cell reselection is the corresponding process when the UE is already camping on a cell, i.e. the process of finding a better cell to camp on than the current serving (camping) cell and start camping on that cell instead.

Camping on a cell means that the UE is synchronized with the cell's downlink transmissions, ensures that up to date system information (that is relevant for the UE's operation) for the cell is stored in the UE, monitors the physical downlink control channel (PDCCH) for paging transmissions, and monitors the channel quality to assess the cell's suitability as a serving cell in relation to other cells to potentially camp on (by performing cell reselection). A UE camps on a cell while in the RRC_IDLE and RRC_INACTIVE states. The cell a UE is camping on is also referred to as the UE's serving cell. Cell selection and cell reselection in NR are specified in 3GPP TS 38.304.

Of central importance in the cell selection (and cell reselection) procedure is the cell selection criterion, S, which is specified as follows in 3GPP TS 38.304: the cell selection criterion S is fulfilled when:

Srxlev>0 AND

Squal>0

where:

Srxlev=Qᵣₓₗₑᵥₘₑₐₛ−(Qᵣₓₗₑᵥₘᵢₙ+Q_{rxlevminoffst})−P_{compensation}−Qoffsetₜₑₘₚ

Squal=Q_{qualmeas}−(Q_{qualmin}+Q_{qualminoffset})−Qoffsetₜₑₘₚ

where:

| | |
|---|---|
| Srxlev | Cell selection RX level value (dB) |
| Squal | Cell selection quality value (dB) |
| Qoffsetₜₑₘₚ | Offset temporarily applied to a cell as specified in TS |
| | 38.331 (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE |
| | supports SUL frequency for this cell, Qrxlevmin is |
| | obtained from q-RxLevMinSUL, if present, in SIB1, SIB2 |
| | and SIB4, additionally, if Q_{rxlevminoffsetcellSUL} is present in |
| | SIB3 and SIB4 for the concerned cell, this cell specific |
| | offset is added to the corresponding Qrxlevmin to achieve |
| | the required minimum RX level in the concerned cell; |
| | else Qrxlevmin is obtained from q-RxLevMin in SIB1, |
| | SIB2 and SIB4, additionally, if Q_{rxlevminoffsetcell} is present in |
| | SIB3 and SIB4 for the concerned cell, this cell specific |
| | offset is added to the corresponding Qrxlevmin to achieve |
| | the required minimum RX level in the concerned cell. |
| Q_{qualmin} | Minimum required quality level in the cell (dB). |
| | Additionally, if Q_{qualminoffsetcell} is signalled for the |
| | concerned cell, this cell specific offset is added to achieve |
| | the required minimum quality level in the concerned cell. |
| Q_{rxlevminoffset} | Offset to the signalled Qᵣₓₗₑᵥₘᵢₙ taken into account in the |
| | Srxlev evaluation as a result of a periodic search for a |
| | higher priority PLMN while camped normally in a |
| | VPLMN, as specified in TS 23.122. |
| Q_{qualminoffset} | Offset to the signalled Q_{qualmin} taken into account in the |
| | Squal evaluation as a result of a periodic search for a |
| | higher priority PLMN while camped normally in a |
| | VPLMN, as specified in TS 23.122. |
| P_{compensation} | For FR1, if the UE supports the additionalPmax in the |
| | NR-NS-PmaxList, if present, in SIB1, SIB2 and SIB4: |
| | max(P_{EMAX1} − P_{PowerClass}, 0) − (min(P_{EMAX2}, |
| | P_{PowerClass}) − min(P_{EMAX1}, P_{PowerClass})) (dB); |
| | else: |
| | max(P_{EMAX1} − P_{PowerClass}, 0) (dB) |
| | For FR2, P_{compensation} is set to 0. |
| P_{EMAX1}, | Maximum TX power level of a UE may use when |
| P_{EMAX2} | transmitting on the uplink in the cell (dBm) defined as |
| | P_{EMAX} in TS 38.101. If UE supports SUL frequency for |
| | this cell, PE_{MAX1} and P_{EMAX2} are obtained from the |
| | p-Max for SUL in SIB1 and NR-NS-PmaxList for SUL |
| | respectively in SIB1, SIB2 and SIB4 as specified in TS |
| | 38.331, else P_{EMAX1} and P_{EMAX2} are obtained from the |
| | p-Max and NR-NS-PmaxList respectively in SIB1, SIB2 |
| | and SIB4 for normal UL as specified in TS 38.331. |
| P_{PowerClass} | Maximum RF output power of the UE (dBm) according |
| | to the UE power class as defined in TS 38.101-1. |

Another central concept in the cell selection and cell reselection procedures is a “suitable cell”. In brief, a suitable cell is a cell that fulfils the cell selection criterion and in which the UE can receive normal service.

FIG. 2 is a flow diagram illustrating the states and state transitions for a UE cell selection and cell reselection in RRC IDLE or RRC INACTIVE state. There are two variants of cell selection in NR.

One is initial cell selection, where the UE has no prior knowledge of which radio frequency channels are NR frequencies, in which case the UE scans all radio frequency channels in the NR bands according to its capabilities to find a suitable cell to select and camp on.

The other is cell selection by leveraging stored information, where the UE has stored previously acquired information about frequencies and possibly also cell parameters, which it utilizes to streamline the procedure of selecting a suitable cell to camp on.

In TS 38.304, the cell selection variants are specified as follows. Cell selection is performed by one of the following two procedures. The first procedure is initial cell selection (no prior knowledge of which RF channels are NR frequencies): (a) the UE shall scan all RF channels in the NR bands according to its capabilities to find a suitable cell; (b) on each frequency, the UE need only search for the strongest cell, except for operation with shared spectrum channel access where the UE may search for the next strongest cell(s); and (c) once a suitable cell is found, this cell shall be selected.

The second procedure is cell selection by leveraging stored information: (a) this procedure requires stored information of frequencies and optionally also information on cell parameters from previously received measurement control information elements or from previously detected cells; (b) once the UE has found a suitable cell, the UE shall select it; and (c) if no suitable cell is found, the initial cell selection procedure described above shall be started.

Priorities between different frequencies or radio access technologies (RATs) provided to the UE by system information or dedicated signalling are not used in the cell selection process.

Cell reselection involves reselection between cells on the same carrier frequency, between cells on different carrier frequencies as well as between different RATs (on different carrier frequencies).

For cell reselection between different carrier frequencies and RATs, the network can configure priorities which govern how the UE performs cell reselection between carrier frequencies and RATs. The network may further configure threshold-based conditions that must be fulfilled for inter-frequency/RAT cell reselection to take place. The carrier frequency and RAT priorities and the thresholds governing inter-frequency and inter-RAT cell reselection may be configured through the broadcast system information and the carrier frequency and RAT priorities may also be configured through dedicated signaling using the RRCRelease message.

For cell reselection to a higher priority carrier frequency or RAT, it suffices that the concerned cell's quality exceeds a configured threshold. For cell reselection to a lower priority carrier frequency or RAT, the concerned cell's quality has to exceed a configured threshold and the serving cell's quality has to be below another configured threshold. Cell reselection to a cell on a carrier frequency with equal priority, including the current carrier frequency (i.e., intra-frequency cell reselection) is based on a cell ranking procedure which is described further below.

Cell reselection to a higher priority RAT/carrier frequency has precedence over a lower priority RAT/frequency, if multiple cells of different priorities fulfil the cell reselection criteria. If multiple cells fulfil the cell reselection criteria on the selected (i.e., highest priority) carrier frequency and this carrier frequency is an NR carrier, the UE reselects to the highest ranked of these cells according to the above-mentioned cell ranking procedure. If multiple cells fulfil the cell reselection criteria on the selected (i.e. highest priority) (non-NR) RAT, the UE reselects to one of these cells in accordance with the criteria that apply for that RAT.

If cells on multiple carrier frequencies and/or RATs fulfil the cell reselection criteria, the UE should reselect to a cell on the carrier frequency or RAT with the highest priority (out of the ones for which there are cells meeting the cell reselection criteria). If multiple cells fulfil the cell reselection criteria on this carrier frequency/RAT, the UE uses the above described cell ranking.

For intra-frequency cell reselection and inter-frequency cell reselection to equal priority carrier frequencies, when multiple NR cells with equal priority fulfil the cell reselection criteria, including both intra-frequency cells and inter-frequency cells (where the inter-frequency carrier frequencies have a priority that is equal to the priority of the UE's current carrier frequency), the UE uses a cell ranking procedure to identify the best (highest ranked) cell to reselect to. The cell ranking is performed as follows.

For each cell involved in the cell ranking, the UE calculates a ranking value (denoted R n for a neighbor cell and R s for the serving cell) according to the following two formulae (one for the serving cell and one for neighbor cells):

Rₛ=Q_{meas,s}+Q_{hyst}−Qoffsetₜₑₘₚ

Rₙ=Q_{meas,n}−Q_{offset}−Qoffsetₜₑₘₚ

where:

| | |
|---|---|
| Qₘₑₐₛ | RSRP measurement quantity used in cell |
| | reselections. |
| Qoffset | For intra-frequency: Equals to Qoffset_{s,n}, if Qoffset_{s,n} |
| | is valid, otherwise this equals to zero. |
| | For inter-frequency: Equals to Qoffset_{s,n} plus |
| | Qoffset_{frequency}, if Qoffset_{s,n} is valid, otherwise this |
| | equals to Qoffset_{frequency}. |
| Qoffsetₜₑₘₚ | Offset temporarily applied to a cell as specified in |
| | 3GPP TS 38.331. |

To determine a cell's reference signal receive power (RSRP) (Q_{meas,s} for the serving cell, Q_{meas,n} for a neighbor cell) the UE measures the RSRP of each of the cell's synchronization signal blocks (SSBs) and calculates the linear average of a set of the resulting RSRP values. The set of SSB RSRP values to base the averaging on is determined by two parameters configured in the system information: an RSRP threshold, absThreshSS-BlocksConsolidation, which the RSRP of an SSB must exceed for the SSB's RSRP value to be part of the average calculation, and an integer parameter, nrofSS-BlocksToAvearge, representing the maximum number of RSRP values to be used in the averaging. That is, the UE calculates the average (in the linear domain) of the up to nrofSS-BlocksToAvearge highest RSRP values exceeding absThreshSS-BlocksConsolidation. If less then nrofSS-BlocksToAvearge RSRP values exceed absThreshSS-BlocksConsolidation, the UE calculates the linear average of the RSRP values that exceed absThreshSS-BlocksConsolidation. If no SSB RSRP value exceeds absThreshSS-BlocksConsolidation, the UE determines the cell RSRP as the RSRP of the SSB with the highest RSRP in the cell.

Both nrofSS-BlocksToAverage and absThreshSS-BlocksConsolidation are optional to configure. If either of them is absent, the UE determines the cell RSRP as the RSRP of the SSB with the highest RSRP in the cell.

As one option, the UE reselects to (or remains in) the highest ranked cell, i.e. the one with the highest R (Rₙ or Rₛ) value, according to the above algorithm. That is, if one of the neighbor cells is ranked the highest, the UE reselects to that cell, while if the serving cell gets the highest rank, then the UE remains camping on the current serving cell.

As another option, the network may configure an offset range in relation to the highest calculated R value (Rₙ or Rₛ), denoted rangeToBestCell. With this option, any non-highest ranked cell whose ranking value, Rₙ or Rₛ, is closer to the highest R value than rangeToBestCell, are qualified to a second round, where the UE selects the cell to reselect to (or remain camping on, in case the serving cell is selected) based on the number of SSBs each cell has with RSRP values above absThreshSS-BlocksConsolidation. If two or more of these cells have the same number of SSBs with RSRP above absThreshSS-BlocksConsolidation, the UE selects the cell with the highest R value. If rangeToBestCell is configured, but absThreshSS-BlocksConsolidation is not configured, the UE considers that there is one SSB above the threshold for each cell on that frequency.

For the any of the above described conditions for cell reselection to result in a cell reselection, it must persist for a configurable time period (t-reselectionNR for NR or t-reselectionEUTRA for EUTRA, which respectively correspond to the parameters Treselection_{NR} and Treselection_{EUTRA} in 3GPP TS 38.304), which is configured in the system information. An additional condition is that no preceding cell reselection has occurred during the last 1 second.

If the cell a UE has selected for reselection is found to be not suitable, the UE will not reselect to that cell and its further behavior is specified in section 5.2.4.4 in 3GPP TS 38.304.

The standard has several built-in mechanisms for limiting the amount of neighbor cell measurements a UE needs to perform and the frequency of its cell reselections. To this end, the UE may choose not to perform intra-frequency measurements, if the serving cell fulfils Srxlev>S_{IntraSearchP} and Squal>S_{IntraSearchQ}, Similarly, if the serving cell fulfils Srxlev>S_{nonIntraSearchP} and Squal>S_{nonIntraSearchQ}, the UE may choose not to perform measurements on NR inter-frequencies or inter-RAT frequency cells of equal or lower priority. However, the UE shall not refrain from measuring on NR inter-frequencies or inter-RAT frequencies with a reselection priority higher than the reselection priority of the current NR frequency.

The cell reselection rules in 3GPP TS 38.304 further limit the maximum frequency of cell reselections to once per second, i.e., according to the specified cell reselection rules a UE must camp on a cell for at least one second before it can reselect to another cell. In addition, a cell reselection condition, in terms of measured neighbor cell quality (and, when applicable, serving cell quality) must be fulfilled during the time period Treselection_{RAT} before it can trigger a cell reselection, where Treselection_{RAT} is configurable in the range 0-7 seconds.

The use of a hysteresis, realized by the configurable Q_{hyst} parameter in the ranking formula for the serving cell (i.e., in the formula Rₛ=Q_{meas,s}+Q_{hyst}−Qoffsetₜₑₘₚ), also serves to reduce the frequency of cell reselections because it favors remaining in the current serving cell.

Furthermore, in 3GPP release 16 of NR, the network may configure a UE to be allowed to relax its neighbor cell measurements for cell reselection evaluation when certain conditions are fulfilled that indicate that the need or probability for a cell reselection in the near future is low.

Another procedure is available that does not reduce the number or frequency of neighbor cell measurements, but instead reduces the effort a UE spends on a neighbor cell measurement. This is the SSB Measurement Timing Configuration (SMTC), by which the network can configure a periodic time window per carrier frequency in which the SSB transmissions that the RRC_ILDE or RRC_INACTIVE UE measures on occurs. For neighbor cell measurements in RRC_CONNECTED state, a UE may be configured with more advanced SMTC, including cell specific SMTC.

### Satellite Communications

There is an ongoing resurgence of satellite communications. Several plans for satellite networks have been announced in the past few years. The target services vary, from backhaul and fixed wireless, to transportation, to outdoor mobile, to Internet of things (IoT). Satellite networks may complement mobile networks on the ground by providing connectivity to underserved areas and multicast/broadcast services.

To benefit from the strong mobile ecosystem and economy of scale, adapting the terrestrial wireless access technologies including LTE and NR for satellite networks is drawing significant interest. For example, 3GPP completed an initial study in Release 15 on adapting NR to support non-terrestrial networks (mainly satellite networks). This initial study focused on the channel model for the non-terrestrial networks, defining deployment scenarios, and identifying the key potential impacts. 3GPP is conducting a follow-up study item in Release 16 on solutions evaluation for NR to support non-terrestrial networks.

A satellite radio access network usually includes the following components: (a) a gateway that connects satellite network to core network; (b) a satellite that refers to a space-borne platform; (c) terminal that refers to user equipment; (d) a feeder link that refers to the link between a gateway and a satellite; and (e) a service link that refers to the link between a satellite and a terminal.

The link from gateway to terminal is often referred to as the forward link, and the link from terminal to gateway is often referred to as the return link or access link. Depending on the functionality of the satellite in the system, there are two transponder options.

One options is a bent pipe transponder (also referred to as transparent satellite or transparent payload) where a satellite forwards the received signal back to the earth with only amplification and a shift from uplink frequency to downlink frequency. For a regenerative transponder (also referred to as regenerative satellite or regenerative payload, a: satellite includes on-board processing to demodulate and decode the received signal and regenerate the signal before sending it back to the earth.

Depending on the orbit altitude, a satellite may be categorized as low earth orbit (LEO), medium earth orbit (MEO), or geostationary (GEO) satellite. LEO has typical heights ranging from 250-1,500 km, with orbital periods ranging from 90-130 minutes. MEO has typical heights ranging from 5,000-25,000 km, with orbital periods ranging from 2-14 hours. GEO has height at about 35,786 km, with an orbital period of 24 hours.

A communication satellite typically generates several beams over a given area. The footprint of a beam is usually in an elliptic shape, which has been traditionally considered as a cell, but cells consisting of the coverage footprint of multiple beams are excluded. The footprint of a beam is also often referred to as a spotbeam. The footprint of a beam may move over the earth surface with the satellite movement or may be earth fixed with a beam pointing mechanism used by the satellite to compensate for its motion. The size of a spotbeam depends on the system design, which may range from tens of kilometers to a few thousands of kilometers. FIG. 3 illustrates an example architecture of a satellite network with bent pipe transponders.

A study item “Solutions for NR to support Non-Terrestrial Network” is a continuation of a preceding study item “NR to support Non-Terrestrial Networks” (RP-171450), where the objective was to study the channel model for the non-terrestrial networks, to define deployment scenarios and parameters, and to identify the key potential impacts on NR. The results are reflected in 3GPP TR 38.811. The objectives of the study item are to evaluate solutions for the identified key impacts from the preceding study item and to study impact on RAN protocols/architecture. The objectives for layer 2 and above are as follows.

One objective is to study propagation delay, identify timing requirements and solutions on layer 2 aspects, MAC, RLC, RRC, to support non-terrestrial network propagation delays considering FDD and TDD duplexing mode. This includes radio link management.

Another object with respect to handover is to study and identify mobility requirements and necessary measurements that may be needed for handovers between some non-terrestrial space-borne vehicles (such as Non-Geo stationary satellites) that move at much higher speed but over predictable paths.

An object with respect to architecture is to identify needs for the 5G radio access network architecture to support non-terrestrial networks (e.g. handling of network identities).

An object with respect to paging is procedure adaptations for moving satellite foot prints or cells.

The coverage pattern of a non-terrestrial network (NTN) is described in 3GPP TR 38.811 in Section 4.6 as follows. Satellite or aerial vehicles typically generate several beams over a given area. The footprint of the beams are typically elliptic shape.

The beam footprint may be moving over the earth with the satellite or the aerial vehicle motion on its orbit. Alternatively, the beam footprint may be earth fixed, in such case a beam pointing mechanisms (mechanical or electronic steering feature) compensates for the satellite or the aerial vehicle motion.

TABLE 1
Typical beam footprint size

| Attributes | GEO | Non-GEO | Aerial |
|---|---|---|---|
| Beam | 200-1000 km | 100-500 km | 5-200 km |
| footprint | | | |
| size in | | | |
| diameter | | | |

Typical beam patterns of various NTN access networks are depicted in FIG. 4.

A non-terrestrial network typically features the following elements. A NTN includes one or several sat-gateways that connect the NTN to a public data network. A GEO satellite may be fed by one or several sat-gateways which are deployed across the satellite targeted coverage (e.g., regional or even continental coverage). UEs in a cell are served by only one sat-gateway. A Non-GEO satellite may be served successively by one sat-gateway at a time. The system ensures service and feeder link continuity between the successive serving sat-gateways with sufficient time duration to proceed with mobility anchoring and hand-over.

Four scenarios are considered as depicted in Table 2 and are detailed in Table 3.

TABLE 2
Reference scenarios

| | Transparent | Regenerative |
|---|---|---|
| | satellite | satellite |
| GEO based non-terrestrial access network | Scenario A | Scenario B |
| LEO based non-terrestrial access network | Scenario C | Scenario D |

TABLE 3
Reference scenario parameters

| | | LEO based non- |
|---|---|---|
| | | terrestrial access |
| | GEO based non-terrestrial access | network (Scenario C & |
| Scenarios | network (Scenario A and B) | D) |
| Orbit type | Notional station keeping position | Circular orbiting around |
| | fixed in terms of elevation/azimuth | the earth |
| | with respect to a given earth point | |
| Altitude | 35,786 km | 600 km |
| | | 1,200 km |
| Spectrum (service link) | <6 GHz (e.g. 2 GHz) | |
| | >6 GHz (e.g. DL 20 GHz, UL 30 GHz) | |
| Max channel bandwidth | 30 MHz for band <6 GHz | |
| (service link) | 400 MHz for band >6 GHz | |
| Payload | Scenario A : Transparent (including | Scenario C: Transparent |
| | radio frequency function only) | (including radio |
| | Scenario B: regenerative (including | frequency function only) |
| | all or part of RAN functions) | Scenario D: |
| | | Regenerative (including |
| | | all or part of RAN |
| | | functions) |
| Inter-Satellite link | No | Scenario C: No |
| | | Scenario D: Yes |
| Earth-fixed beams | Yes | Scenario C: No (the |
| | | beams move with the |
| | | satellite) |
| | | Scenario D, option 1: |
| | | Yes (steering beams), |
| | | see note 1 |
| | | Scenario D, option 2: |
| | | No (the beams move |
| | | with the satellite) |
| Max beam footprint | 500 km | 200 km |
| diameter at nadir | | |
| Min elevation angle for | 10° | 10° |
| both sat-gateway and | | |
| user equipment | | |
| Max distance between | 40,586 km | 1,932 km (600 km |
| satellite and user | | altitude) |
| equipment at min | | 3,131 km (1,200 km |
| elevation angle | | altitude) |
| Max Round Trip Delay | Scenario A: 562 ms (service and | Scenario C: 25.76 ms |
| (propagation delay only) | feeder links) | (transparent payload: |
| | Scenario B: 281 ms | service and feeder links) |
| | | Scenario D: 12.88 ms |
| | | (regenerative payload: |
| | | service link only) |
| Max delay variation | 16 ms | 4.44 ms (600 km) |
| within a beam (earth | | 6.44 ms (1200 km) |
| fixed user equipment) | | |
| Max differential delay | 1.6 ms | 0.65 ms (*) |
| within a beam | | |
| Max Doppler shift (earth | 0.93 ppm | 24 ppm (*) |
| fixed user equipment) | | |
| Max Doppler shift | 0.000 045 ppm/s | 0.27 ppm/s (*) |
| variation (earth fixed | | |
| user equipment) | | |
| User equipment motion | 1000 km/h (e.g. aircraft) | 500 km/h (e.g. high |
| on the earth | | speed train) |
| | | Possibly 1000 km/h (e.g. |
| | | aircraft) |
| User equipment antenna | Omnidirectional antenna (linear polarisation), assuming 0 dBi | |
| types | Directive antenna (up to 60 cm equivalent aperture diameter in | |
| | circular polarisation) | |
| User equipment Tx | Omnidirectional antenna: UE power class 3 with up to 200 | |
| power | mW Directive antenna: up to 4 W | |
| User equipment Noise | Omnidirectional antenna: 7 dB | |
| figure | Directive antenna: 1.2 dB | |
| Service link | 3GPP defined New Radio | |
| Feeder link | 3GPP or non-3GPP defined Radio | 3GPP or non-3GPP |
| | interface | defined Radio interface |

Each satellite has the capability to steer beams towards fixed points on earth using beamforming techniques. This is applicable for a period of time corresponding to the visibility time of the satellite. Maximum delay variation within a beam (earth fixed user equipment) is calculated based on minimum elevation angle for both gateway and user equipment. Maximum differential delay within a beam is calculated based on maximum beam footprint diameter at nadir.

For scenario D, which is LEO with regenerative payload, both earth-fixed and earth moving beams have been listed. Factoring in the fixed/non-fixed beams results in an additional scenario. The complete list of 5 scenarios in 3GPP TR 38.821 is then:
Scenario A—GEO, transparent satellite, Earth-fixed beams;
Scenario B—GEO, regenerative satellite, Earth fixed beams;
Scenario C—LEO, transparent satellite, Earth-moving beams;
Scenario D1—LEO, regenerative satellite, Earth-fixed beams;
Scenario D2—LEO, regenerative satellite, Earth-moving beams.

When NR or LTE provides the connectivity via satellites, it means that the ground station is a RAN node. Where the satellite is transparent, all RAN functionalities are on the ground which means the sat-gateway has the entire eNB/gNB functionality. For the regenerative satellite payload, part or all, of the eNB/gNB processing may be on the satellite.

Non-GEO satellites move rapidly with respect to any given UE location. As an example, on a 2-hour orbit, a LEO satellite is in view of a stationary UE from horizon to horizon for about 20 minutes. Since each LEO satellite may have many beams, the time during which a UE stays within a beam is typically only a few minutes. The fast pace of satellite movement creates problems for cell (re)selections and handovers of both stationary UEs and moving UEs.

Unlike terrestrial networks, where a cell on the ground is tied to radio communication with a RAN node, in Non-GEO satellite access network, the satellite beams may be moving. There is no fixed correspondence between cells on the ground and satellite beams. The same geographical region on the ground can be covered by different satellites and different beams over time. When one LEO satellite beam moves away from the geographical area, another LEO satellite beam (that may be generated by the same LEO satellite or by a neighboring LEO satellite) moves in and covers the same geographical area. The new satellite may be served by the same or another sat-gateway. From a UE perspective, this means that the ground serving RAN node changes when the sat-gateway changes. This situation is not present in normal terrestrial networks. A similar situation occurs when the serving satellite changes, even if it is connected to the same sat-gateway.

The UEs in a NTN system may typically be rural positioned UEs that are either: (a) stationary, e.g. satellite antennas mounted on a roof top; (b) slow moving UEs, e.g. nautically positioned UEs on a ship moving at moderate speeds; and (c) high speed UEs, e.g. UEs on rural highspeed trains. Given the different types of UEs that may be connected to a NTN system, the network and the UEs need to deal with normal mobility scenarios as experienced in terrestrial networks and the mobility induced by moving RAN nodes.

Also relevant in this context is the concept of a remaining time Tservice until the service link is switched to a different satellite, or a different spot beam. Alternatively, Tservice corresponds to the time until the serving satellite constellation, or spot beam, goes out of coverage. Alternatively, Tservice corresponds to the time until the elevation angle to the serving satellite goes below a threshold defining the suitability of a cell. In summary, Tservice represents a UE's time left to be served in a certain cell. Tservice may be used for deciding random access to a target.

In current 3GPP discussions, the information on when a cell is going to stop serving the area and/or the timing information (e.g., timer or absolute time) about new upcoming cell may be supported at least in Earth-fixed NTN scenario.

There currently exist certain challenges. For example, current cell reselection evaluation processes may be inefficient when not considering an amount of time left to be served in a particular cell.

### SUMMARY

Based on the description above, certain challenges currently exist with cell reselection for non-terrestrial networks (NTN). Certain aspects of the present disclosure and their embodiments may provide solutions to these or other challenges. For example, some embodiments include causing a user equipment (UE) to perform intra-frequency NTN measurements if Tservice is running out or if the UE location is near the serving cell edge. This may be done regardless of the reference signal received power (RSRP) values or other channel quality measures.

Some embodiments may include a new state where if the UE determines Tservice to be less than a given value, the UE scales down the serving cell signal power value such that it triggers intra-frequency NTN cell reselection and/or respective measurements. In some embodiments, when the UE evaluates a higher ranking cell, the UE checks rules for Tservice and location such that an NTN cell is removed from being a highest ranking cell if Tservice is too small or if the UE distance to the center of the concerned cell is too great.

According to some embodiments, a method performed by a wireless device for cell selection or reselection in a NTN comprises determining whether to perform one or more cell selection or reselection measurements based on a cell selection or reselection criteria. The cell selection or reselection criteria is based on a signal quality of a serving cell and a relationship between the wireless device and a satellite or spot beam of the NTN. Upon determining that the cell selection or reselection criteria for performing measurements is satisfied, the method further comprises performing the one or more cell selection or reselection measurements.

In particular embodiments, the relationship between the wireless device and the satellite or spot beam comprises a remaining service time (Tservice) associated with the satellite or spot beam. Determining that the cell selection or reselection criteria for performing measurements is satisfied may comprise determining that Tservice is below a threshold remaining service time value (regardless of the signal quality of the serving cell). Determining that the cell selection or reselection criteria for performing measurements is not satisfied may comprise determining that Tservice is above a threshold remaining service time value (regardless of the signal quality of the serving cell).

In particular embodiments, the threshold remaining service time equals an amount of coexistence time between two satellites or spot beams.

In particular embodiments, the relationship between the wireless device and the satellite or spot beam comprises a location of the wireless device. Determining whether the cell selection or reselection criteria for performing measurements is satisfied may comprise determining whether the wireless device is located within a designated coverage area, determining whether the wireless device is located within a threshold distance of a center of the serving cell, determining whether the wireless device is located within a threshold distance of an edge of the serving cell, determining whether the wireless device is located within a threshold distance of a center of a neighbor cell, and/or determining a direction of movement of the wireless device with respect to a direction of movement of the satellite or spot beam.

In particular embodiments, thresholds for evaluating a signal quality of a serving cell are scaled based on the relationship between the wireless device and the satellite or spot beam.

According to some embodiments, a method performed by a wireless device for cell selection or reselection in a NTN comprises ranking one or more cells subject to a cell selection or reselection evaluation procedure. The ranking is based on a signal quality of each cell of the one or more cells and a relationship between the wireless device and a satellite or spot beam of each cell of the one or more cells. Based on the ranking, the method further comprises choosing one cell of the one or more cells for cell selection or reselection.

In particular embodiments, the relationship between the wireless device and the satellite or spot beam comprises a remaining service time (Tservice) associated with the satellite or spot beam.

In particular embodiments, ranking the one or more cells comprises determining whether Tservice is below a threshold remaining service time value. The threshold remaining service time may equal an amount of coexistence time between two satellites or spot beams.

In particular embodiments, the relationship between the wireless device and the satellite or spot beam comprises a location of the wireless device. Ranking the one or more cells may comprise determining whether the wireless device is located within a designated coverage area, determining whether the wireless device is located within a threshold distance of a center the cell, determining whether the wireless device is located within a threshold distance of an edge of the cell, and/or determining a direction of movement of the wireless device with respect to a direction of movement of the satellite or spot beam.

In particular embodiments, thresholds for evaluating a signal quality of a cell of the one or more cells are scaled based on the relationship between the wireless device and the satellite or spot beam.

According to some embodiments, a wireless device comprises processing circuitry operable to perform any of the wireless device methods described above.

Also disclosed is a computer program product comprising a non-transitory computer readable medium storing computer readable program code, the computer readable program code operable, when executed by processing circuitry to perform any of the methods performed by the wireless device described above.

Certain embodiments may provide one or more of the following technical advantages. For example, particular embodiments provide efficient ways to use Tservice and/or location for cell reselection. For example, defining a near-end-of-service state and conditioning cell reselection rules on that improves cell reselection efficiency.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a block diagram illustrating the fifth generation (5G) radio access network (RAN) architecture;

FIG. 2 is a flow diagram illustrating the states and state transitions for a UE cell selection and cell reselection in RRC_IDLE or RRC_INACTIVE state;

FIG. 3 illustrates an example architecture of a satellite network with bent pipe transponders;

FIG. 4 is a block diagram illustrating example NTN beam patterns;

FIG. 5 is a block diagram illustrating an example wireless network;

FIG. 6 illustrates an example user equipment, according to certain embodiments;

FIG. 7 is flowchart illustrating an example method in a wireless device, according to certain embodiments;

FIG. 8 is flowchart illustrating an example method in a network node, according to certain embodiments;

FIG. 9 illustrates a schematic block diagram of a wireless device and a network node in a wireless network, according to certain embodiments;

FIG. 10 illustrates an example virtualization environment, according to certain embodiments;

FIG. 11 illustrates an example telecommunication network connected via an intermediate network to a host computer, according to certain embodiments;

FIG. 12 illustrates an example host computer communicating via a base station with a user equipment over a partially wireless connection, according to certain embodiments;

FIG. 13 is a flowchart illustrating a method implemented, according to certain embodiments;

FIG. 14 is a flowchart illustrating a method implemented in a communication system, according to certain embodiments;

FIG. 15 is a flowchart illustrating a method implemented in a communication system, according to certain embodiments; and

FIG. 16 is a flowchart illustrating a method implemented in a communication system, according to certain embodiments.

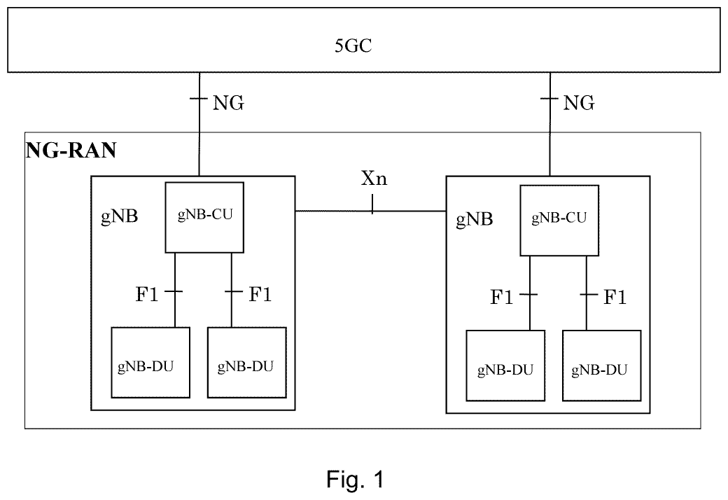

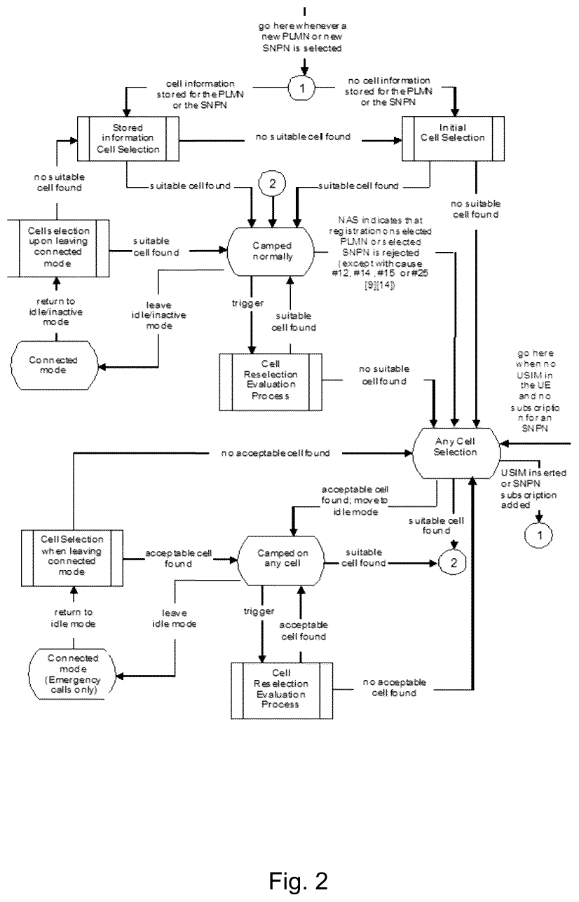

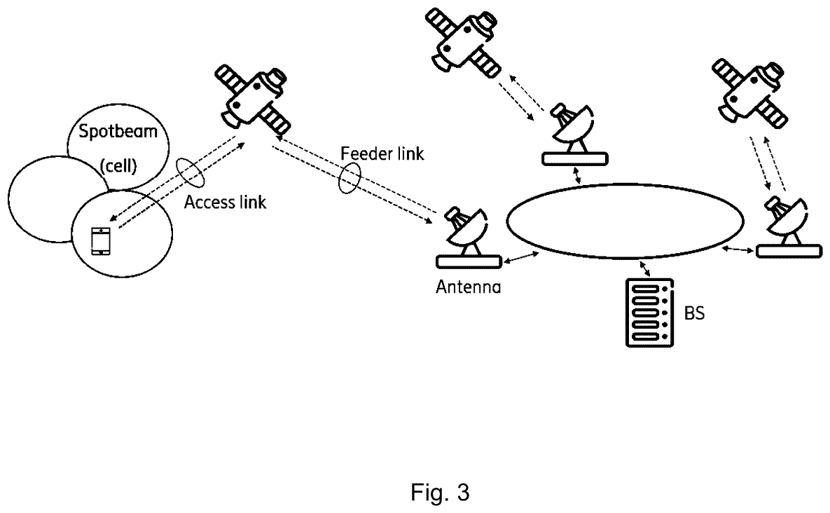

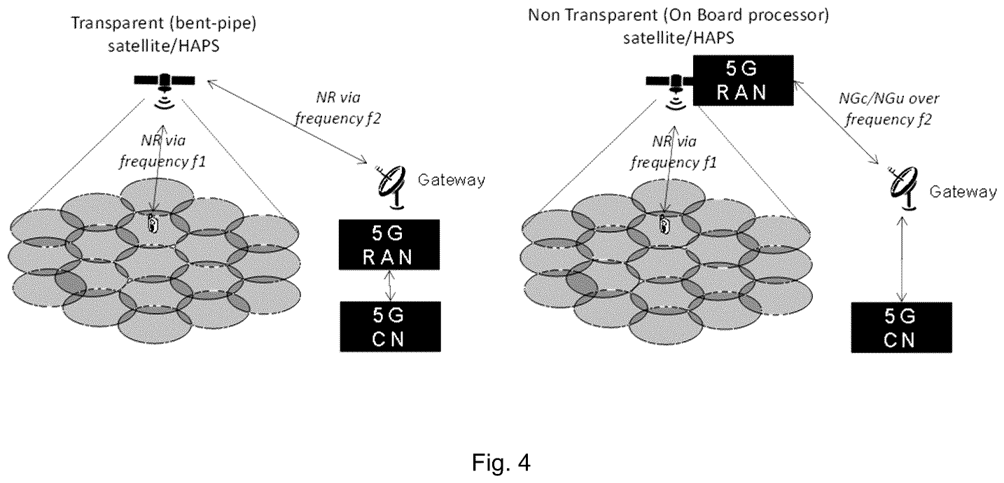

### DETAILED DESCRIPTION

As described above, certain challenges currently exist with cell reselection for non-terrestrial networks (NTN). Certain aspects of the present disclosure and their embodiments may provide solutions to these or other challenges. For example, some embodiments include causing a user equipment (UE) to perform intra-frequency NTN measurements if Tservice is running out or if the UE location is near the serving cell edge. This may be done regardless of the reference signal received power (RSRP) values or other channel quality measures.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

As used herein, the term “Tservice” may be interpreted as the “expected remaining time to be served” (i.e., the time a certain UE can be expected to be served by a certain cell). Equivalent expressions/interpretations for the same concept include “expected time to be served”, “expected time to be served with sufficient channel quality”, “expected time to be served with sufficiently good channel quality”, “expected time to be covered”, “expected time to be covered with sufficient channel quality”, “expected time to be covered with sufficiently good channel quality”, “expected coverage time”, “expected coverage time with sufficient channel quality”, “expected coverage time with sufficiently good channel quality”. In these expressions, “sufficient channel quality” and “sufficiently good channel quality” may refer to a channel quality that exceeds one or more threshold value(s), e.g. related to a UE's perceived reference signal received power (RSRP), reference signal received quality (RSRQ), signal to interference and noise ratio (SINR) or received signal strength indicator (RSSI) (or a pathloss threshold that the UE experienced pathloss or estimated pathloss should be below for the channel quality to be sufficient or sufficiently good).

For convenience, the term “satellite” may be used even when a more appropriate term may be “gNB associated with the satellite”. A gNB associated with a satellite might include both a regenerative satellite, where the gNB is the satellite payload, the gNB may be integrated with the satellite, or a transparent satellite, where the satellite payload is a relay and gNB is on the ground (i.e., the satellite relays the communication between the gNB on the ground and the UE.

Particular embodiments are described in terms of NTNs using the NR radio access technology for communication between the UE and the satellite/gNB, but with minor modifications the embodiments are applicable also in NTNs using other radio access technologies, such as long term evolution (LTE).

Some embodiments may be described by including a Tservice in TS 38.304 under Section 5.2.4 cell reselection evaluation process. Some embodiments modify the measurement rules described in Section 5.2.4.2 in TS 38.304 so that a UE performs measurements when Tservice is running out. For example, a clause may be added specifically for NTN that allows the UE to refrain from performing measurements only if in addition to the usual condition (Srxlev>S_{IntraSearchP} and Squal>S_{IntraSearchQ}) also Tservice is larger than a configured threshold TthresholdNTN. In other words, this means that when Tservice becomes smaller than the threshold, the UE needs to start performing measurements, even if the perceived channel quality is still acceptable.

Below is an example clause that may be added to 3GPP TS 38.304 to implement these new conditions. In this example, the location condition is based on the UE distance to the center of the serving cell:

For NTN, the UE may choose not to perform intra-frequency measurements if
Tservice>TserviceThresholdNTN and
the serving cell fulfils Srxlev>S_{IntraSearchP} and Squal>S_{IntraSearchQ}.

As one example, for earth fixed cells/beams where the old and the new cell covering the same cell area coexist for a certain time (i.e., both cells, e.g. served by different satellites, cover the same area during a coexistence period, e.g. to allow some time for handover of UEs from the old to the new cell). Tservice may be calculated in relation to the time when the old cell will disappear and TserviceThresholdNTN may be set to the duration of the cell coexistence period. This would mean that, irrespective of the serving cell channel quality, a UE would not be allowed to refrain from intra-frequency neighbor cell measurements when the coexistence period has started.

In some embodiments, another subclause is added that allows the UE to refrain from performing measurements when Tservice is larger than a configured threshold TserviceThresholdNTN, and the UE is located close to the cell center, or at least far from the cell border/edge. The second condition may be determined either by the distance to the cell center being smaller than a configured threshold value, distanceToServingCellCenterThreshold, or if the UE is inside a configured region (e.g., referred to as a “no-measurement zone”), e.g. an ellipse or a polygon, or if the UE is inside an area representing an estimation of the serving cell coverage area and the UE distance from the border of this area is larger than a configured threshold, distanceToServingCellEdgeThreshold. In other words, the UE needs to start performing measurements when either Tservice becomes smaller than the threshold, or when the UE moves outside the configured “no-measurement zone” region, regardless of the perceived channel quality.

Below is an example clause that could be added to 3GPP TS 38.304 to implement these new conditions. In this example, the location condition is based on the UE distance to the center of the serving cell:

For NTN, the UE may choose not to perform intra-frequency measurements only if Tservice>TserviceThresholdNTN and either
the serving cell fulfils Srxlev>S_{IntraSearchP} and Squal>S_{IntraSearchQ}, or
the UE's distance to the center of the serving cell, distanceToServingCellCenter, is smaller than distanceToServingCellCenterThreshold (i.e. distanceToServingCellCenter<distanceToServingCellCenterThreshold).

As another example of text that could be added to 3GPP TS 38.304, the location condition is based on a configured no-measurement zone:

For NTN, the UE may choose not to perform intra-frequency measurements only if Tservice>TserviceThresholdNTN and either
the serving cell fulfils Srxlev>S_{IntraSearchP} and Squal>S_{IntraSearchQ}, or

the UE's location is inside the configured no-measurement zone (noMeasurementZone).

In yet another example of text that could be added to 3GPP TS 38.304, the location condition is based on a configured estimated cell coverage area and the UE distance to the border/edge of this area:

For NTN, the UE may choose not to perform intra-frequency measurements only if Tservice >TserviceThresholdNTN and either
the serving cell fulfils Srxlev >Sintrasearchp and Squal >SintrasearchQ, or
the UE's location is inside the configured estimated coverage area of the serving cell (servingCellArea) and the UE's distance to the border of the configured estimated coverage area of the serving cell, distanceToServingCellEdge, is greater than distanceToServingCellEdgeThreshold (i.e., distanceToServingCellEdge>distanceToServingCellEdgeThreshold).

All of the relevant information in the above described various embodiment variants, including TserviceThresholdNTN, the cell's center position, distanceToServingCellCenterThreshold, the no measurement zone (noMeasurementZone), the estimated cell coverage area (servingCellArea) and/or distanceToServingCellEdgeThreshold may be configured via the broadcast system information or using dedicated signaling such as an RRCRelease message. Parts of this information may also be specified in the standard, such as the shape of no measurement zone or a cell coverage area. The configuration, or definition, of a no-measurement zone or a cell coverage area may, e.g., including shape, size, rotational angle (e.g., in relation to north), and/or location of the area/zone, where the location may include a geographical position assigned to a defined point on the shape of the area/zone or a relation of such a defined point to the cell center. For a moving cell, the location of the cell center, the no-measurement zone and/or the estimated cell coverage area may be defined in relation to the satellite, so that they follow the movement of the satellite (and thus the movement of the cell).

In some embodiments, the UE is configured with information of one or more cell(s), e.g. via the broadcast system information and/or via dedicated signaling, such as an RRCRelease message, enabling the UE to determine the center position of the serving cell and the center positions of one or more (preferably all) neighbor cell(s), and the UE is allowed to refrain from performing intra-frequency measurements for cell reselection assessment if Tservice exceeds TserviceThresholdNTN and the UE distance to the center position of the serving cell is smaller than the UE distance to all the neighbor cell center positions and the difference between the UE distance to the closest neighbor cell center position and the UE distance to the serving cell center position is greater than a configured (or specified) threshold, cellCenterDistanceDifferenceThreshold. The cellCenterDistanceDifferenceThreshold may be configured via the broadcast system information or using dedicated signaling, such as an RRCRelease message. The information enabling the UE to determine the cell centers of the concerned cell may, e.g., consist of location information for each cell, e.g., in the form of coordinates on the WGS 84 ellipsoid, which in the case of a moving cell may be complemented with information about the cell or the cell center position movement. This movement information (if any) may as one option be derived from ephemeris data associated with the satellite serving the cell.

Continuing the above sequence of examples of clauses that could be included in 3GPP TS 38.304 to define how Tservice or the UE location may be used to determine when the UE is allowed to refrain from intra-frequency neighbor cell measurements, the following is an example of a similar clause where the location condition is based on the difference between the UE distance(s) to the center(s) of neighbor cell(s) and the UE distance to the center of the serving cell:

For NTN, the UE may choose not to perform intra-frequency measurements only if Tservice>TserviceThresholdNTN and either
the serving cell fulfils Srxlev>S_{IntraSearchP} and Squal>S_{IntraSearchQ}, or
the UE's distance to the center of the serving cell is smaller than the distance to the closest neighbor cell center by at least an offset cellCenterDistanceDifferenceThreshold (i.e., distanceToServingCellCenter<distanceToClosestNeighborCellCenter−cellCenterDistanceDifferenceThreshold).

With distanceToServingCellCenter being the UE distance to the center position of the serving cell and distanceToNeighborCellCenter k being the UE distance to the cell center position of neighbor cell k, wherein information about N neighbor cells center points have been provided (i.e., k=1, . . . N), the above clause may be differently expressed as follows:

For NTN, the UE may choose not to perform intra-frequency measurements only if Tservice>TserviceThresholdNTN and either
the serving cell fulfils Srxlev>S_{IntraSearchP} and Squal>S_{IntraSearchQ}, or
the UE distance to the center of the serving cell fulfills distanceToServingCellCenter<MIN((distanceToNeighborCellCenterₖ)ₖ₌₁^{N}).

With distanceToNeighborCellCenterₖ being the UE distance to the cell center position of neighbor cell k, wherein information about N neighbor cells center points have been provided (i.e., k=1, . . . N), the above clause may be differently expressed as follows:

For NTN, the UE may choose not to perform intra-frequency measurements only if Tservice>TserviceThresholdNTN and either
the serving cell fulfils Srxlev>S_{IntraSearchP} and Squal>S_{IntraSearchQ}, or
the UE's distance to the center of the serving cell fulfills distanceToNeighborCellCenterThresholdNTN<MIN((distanceToNeighborCellCenterₖ)ₖ₌₁^{N}).

In some embodiments, only the UE's Tservice with respect to a neighbor cell(s), i.e., say Tservice,neighbor, to differentiate it from Tservice with respect to the serving cell, is included in the condition for not performing intra-frequency measurements. This can be expressed as follows for one of the cases mentioned above, but it can as well be applied to any other cases above:

For NTN, the UE may choose not to perform intra-frequency measurements if
Tservice,neighbor<TserviceThresholdNTNneighbor and
the serving cell fulfils Srxlev>S_{IntraSearchP} and Squal>S_{IntraSearchQ}.

In some embodiments, the UE's Tservice with respect to a serving cell and Tservice with respect to a neighbor cell(s), i.e., say Tservice,neighbor, are included in the condition for not performing intra-frequency measurements. This can be expressed as follows for one of the cases mentioned above, but it can as well be applied to any other cases above:

For NTN, the UE may choose not to perform intra-frequency measurements if
Tservice>TserviceThresholdNTN or Tservice,neighbor<TserviceThresholdNTNneighbor
the serving cell fulfils Srxlev>S_{IntraSearchP} and Squat>S_{IntraSearchQ}.

In some embodiments, the UE remaining time to be served in a cell (Tservice) is not included in the condition for when a UE in RRC_IDLE or RRC_INACTIVE state is allowed to refrain from intra-frequency neighbor cell measurements, and this is instead determined based on only a condition related to the UE location or a condition related to the UE location combined with a channel quality condition. The following are some examples of how some variants of such conditions may be expressed in similar 3GPP TS 38.304 clauses as for the preceding examples:

### Example 1

For NTN, the UE may choose not to perform intra-frequency measurements if the UE distance to the center of the serving cell, distanceToServingCellCenter, is smaller than distanceToServingCellCenterThreshold (i.e., distanceToServingCellCenter<distanceToServingCellCenterThreshold).

### Example 2

For NTN, the UE may choose not to perform intra-frequency measurements if the UE location is inside the configured no-measurement zone (noMeasurementZone).

### Example 3

For NTN, the UE may choose not to perform intra-frequency measurements if the UE location is inside the configured estimated coverage area of the serving cell (servingCellArea) and the UE distance to the border of the configured estimated coverage area of the serving cell, distanceToServingCellEdge, is greater than distanceToServingCellEdgeThreshold (i.e., distanceToServingCellEdge>distanceToServingCellEdgeThreshold).

### Example 4

For NTN, the UE may choose not to perform intra-frequency measurements if the UE distance to the center of the serving cell is smaller than the distance to the closest neighbor cell center by at least an offset cellCenterDistanceDifferenceThreshold (i.e., distanceToServingCellCenter<distanceToClosestNeighborCellCenter−cellCenterDistanceDifferenceThreshold).

### Example 5

For NTN, the UE may choose not to perform intra-frequency measurements if
the serving cell fulfils Srxlev>S_{IntraSearchP} and Squal>S_{IntraSearchQ}, or
the UE distance to the center of the serving cell, distanceToServingCellCenter, is smaller than distanceToServingCellCenterThreshold (i.e., distanceToServingCellCenter distanceToServingCellCenterThreshold).

### Example 6

For NTN, the UE may choose not to perform intra-frequency measurements if
the serving cell fulfils Srxlev>S_{IntraSearchP} and Squal>S_{IntraSearchQ}, or
the UE location is inside the configured no-measurement zone (noMeasurementZone).

### Example 7

For NTN, the UE may choose not to perform intra-frequency measurements if
the serving cell fulfils Srxlev>S_{IntraSearchP} and Squal>S_{IntraSearchQ}, or
the UE location is inside the configured estimated coverage area of the serving cell (servingCellArea) and the UE distance to the border of the configured estimated coverage area of the serving cell, distanceToServingCellEdge, is greater than distanceToServingCellEdgeThreshold (i.e., distanceToServingCellEdge>distanceToServingCellEdgeThreshold).

### Example 8

For NTN, the UE may choose not to perform intra-frequency measurements if
the serving cell fulfils Srxlev>S_{IntraSearchP} and Squal>S_{IntraSearchQ}, or
the UE distance to the center of the serving cell is smaller than the distance to the closest neighbor cell center by at least an offset cellCenterDistanceDifferenceThreshold (i.e., distanceToServingCellCenter<distanceToClosestNeighborCellCenter−cellCenterDistanceDifferenceThreshold).

### Example 9

For NTN, the UE may choose not to perform intra-frequency measurements if
the serving cell fulfils Srxlev>S_{IntraSearchP} and Squal>S_{IntraSearchQ}, and
the UE distance to the center of the serving cell, distanceToServingCellCenter, is smaller than distanceToServingCellCenterThreshold (i.e., distanceToServingCellCenter<distanceToServingCellCenterThreshold).

### Example 10

For NTN, the UE may choose not to perform intra-frequency measurements if
the serving cell fulfils Srxlev>S_{IntraSearchP} and Squal>S_{IntraSearchQ}, and
the UE location is inside the configured no-measurement zone (noMeasurementZone).

### Example 11

For NTN, the UE may choose not to perform intra-frequency measurements if
the serving cell fulfils Srxlev>S_{IntraSearchP} and Squal>S_{IntraSearchQ}, and
the UE location is inside the configured estimated coverage area of the serving cell (servingCellArea) and the UE distance to the border of the configured estimated coverage area of the serving cell, distanceToServingCellEdge, is greater than distanceToServingCellEdgeThreshold (i.e., distanceToServingCellEdge>distanceToServingCellEdgeThreshold).

### Example 12

For NTN, the UE may choose not to perform intra-frequency measurements if
the serving cell fulfils Srxlev>S_{IntraSearchP} and Squal>S_{IntraSearchQ}, and
the UE distance to the center of the serving cell is smaller than the distance to the closest neighbor cell center by at least an offset cellCenterDistanceDifferenceThreshold (i.e., distanceToServingCellCenter<distanceToClosestNeighborCellCenter−cellCenterDistanceDifferenceThreshold).

An alternative to adding clauses like the ones above to 3GPP TS 38.304 is to take the Tservice and its possible soon to come expiration into account in the cell reselection process (in particular when a UE in RRC_IDLE or RRC_INACTIVE state is allowed to refrain from intra-frequency neighbor cell measurements) by defining a new UE state, similar to the existing mobility states, or as a substate to RRC_IDLE and/or RRC_INACTIVE state. When in this “Near-end-of-service” state, which may optionally be seen as a substate of RRC_IDLE and/or RRC_INACTIVE state, the UE scales the measured serving cell signal power or signal quality measure, e.g. by multiplying by a positive scaling factor smaller than one (which is equivalent to adding a negative value if the scaled quantity is measured in dB or dBm) to artificially reduce the perceived channel quality and thus trigger cell reselection and/or respective measurements.

Similar to the conditions described above, the UE determines to be in the Near-end-of-service state based on a condition related to Tservice or a condition related to the UE location, e.g. one of the following conditions: (a) if Tservice is smaller than a configured (or specified) threshold; (b) if the UE is located outside a configured “no-measurement” zone (i.e., an area where the UE is not required to perform measurements); (c) if the UE is located inside the configured estimated coverage area of the serving cell (servingCellArea) and the UE distance to the border of the configured estimated coverage area of the serving cell is smaller than a configured (or specified) threshold; (d) if the distance to the cell center is larger than a configured (or specified) threshold value; or (e) if the UE distance to the center of the serving cell is larger than the distance to the closest neighbor cell center by at least a configured (or specified) offset.

Otherwise, the UE is in the Normal state (i.e., “normal RRC_IDLE” state or “normal RRC_INACTIVE” state), and no scaling is applied. Some embodiments include variations of the state definition, e.g., requiring that both the Tservice condition and the distance to the service cell center condition are fulfilled for the UE to apply the scaling. Fulfilment of any other combination of the conditions above may also be used as the trigger for scaling.

Below is a subsection that may be added to 3 GPP TS 38.304 to define the new UE state. For certain parts of the text (specifically the criteria for respectively Normal state and Near-end-of-service state), different alternatives are given (indicated by “<Alternative X, start>” and “<Alternative X, end>), which provide different possible versions of the text.

The Near-end-of-service state is determined either via Tservice or by the UE location. Note that the conditions presented below are examples and the final condition may be a different combination and/or of the individual conditions. For example, a state X may be determined based on Tservice only or based on Tservice and location.

### State Detection Criteria

Normal state:
<Alternative 1, start>
   If Tservice is larger than threshold TserviceThresholdNTN.
<Alternative 1, end>
<Alternative 2, start>
   If distance to cell center is smaller than threshold distanceToServingCellCenterThreshold.
<Alternative 2, end>
<Alternative 3, start>
If UE location is inside a configured no-measurement zone.
<Alternative 3, end>
<Alternative 4, start>
   If the UE's location is inside a configured estimated coverage area of the serving cell and its distance to the border of this area is greater than threshold distanceToServingCellEdgeThreshold.
<Alternative 4, end>
<Alternative 5, start>
   If the distance to the serving cell center is smaller than the distance to any other cell center and the difference between the distance to the closest center of any non-serving cell (i.e., any other cell than the serving cell) and the distance to the center of the serving cell is greater than threshold cellCenterDistanceDifferenceThreshold.
<Alternative 5, end>
<Alternative 6, start>
   If Tservice is larger than threshold TserviceThresholdNTN OR
   distance to cell center is smaller than threshold distanceToServingCellCenterThreshold.
<Alternative 6, end>
<Alternative 7, start>
   If Tservice is larger than threshold TserviceThresholdNTN OR
   UE location is inside a configured no-measurement zone.
<Alternative 7, end>
<Alternative 8, start>
   If Tservice is larger than threshold TserviceThresholdNTN OR
   If the UE's location is inside a configured estimated coverage area of the serving cell and its distance to the border of this area is greater than threshold distanceToServingCellEdgeThreshold.
<Alternative 8, end>
<Alternative 9, start>
   If Tservice is larger than threshold TserviceThresholdNTN OR
   If the distance to the serving cell center is smaller than the distance to any other cell center and the difference between the distance to the closest center of any non-serving cell (i.e., any other cell than the serving cell) and the distance to the center of the serving cell is greater than threshold cellCenterDistanceDifferenceThreshold.
<Alternative 9, end>
<Alternative 10, start>
   <The criteria for Normal state may be any combination the above alternative criteria combined with logical “OR” operators.>
<Alternative 10, end>
   Near-end-of-service state:
<Alternative 1, start>
   If Tservice is smaller than threshold TserviceThresholdNTN.
<Alternative 1, end>
<Alternative 2, start>
   If distance to cell center is larger than threshold distanceToServingCellCenterThreshold.
<Alternative 2, end>
<Alternative 3, start>
   If UE location is outside a configured no-measurement zone.
<Alternative 3, end>
<Alternative 4, start>
   If the UE location is outside a configured estimated coverage area of the serving cell or if the UE location is inside this area, but its distance to the border of the area is smaller than threshold distanceToServingCellEdgeThreshold.
<Alternative 4, end>
<Alternative 5, start>
   If the distance to any other cell center is smaller than the distance to the serving cell center, or if the distance to the serving cell center is smaller than the distance to any other cell center but the difference between the distance to the closest other cell center and the distance to the serving cell center is smaller than threshold cellCenterDistanceDifferenceThreshold.
<Alternative 5, end>
<Alternative 6, start>
   If Tservice is larger than threshold TserviceThresholdNTN OR
   distance to cell center is smaller than threshold distanceToServingCellCenterThreshold.
<Alternative 6, end>
<Alternative 7, start>
   If Tservice is larger than threshold TserviceThresholdNTN OR
   UE location is inside a configured no-measurement zone.
<Alternative 7, end>
<Alternative 8, start>
   If Tservice is larger than threshold TserviceThresholdNTN OR
   If the UE location is outside a configured estimated coverage area of the serving cell or if the UE location is inside this area, but its distance to the border of the area is smaller than threshold distanceToServingCellEdgeThreshold.
<Alternative 8, end>
<Alternative 9, start>
   If Tservice is larger than threshold TserviceThresholdNTN OR
   If the distance to any other cell center is smaller than the distance to the serving cell center, or if the distance to the serving cell center is smaller than the distance to any other cell center but the difference between the distance to the closest other cell center and the distance to the serving cell center is smaller than threshold cellCenterDistanceDifferenceThreshold.
<Alternative 9, end>
<Alternative 10, start>
   <The criteria for Near-end-of-service state may be any combination the above alternative criteria combined with logical “OR” operators.>
<Alternative 10, end>
   State transitions:
The UE shall:
   if the criteria for Near-end-of-service state is detected:
      enter Near-end-of-service state.
   else if the criteria for Normal state is detected:
      enter Normal state.
If the UE is in Near-end-of-service state, the UE shall apply the following scaling rules:
   If Normal state is detected:
      no scaling is applied.
   If Near-end-of-service state is detected:
      Scale Srxlev, Squal and the serving cell's ranking criterion/value, Rₛ, as described in section X.

Optionally, a hysteresis may be applied for the conditions triggering state transitions to avoid a UE switching quickly back and forth between Normal state and Near-end-of-service state.

Scaling of Srxlev, Squal and Rₛ in the Near-end-of-service state is to be regarded as an example. Other examples may be to apply scaling only to Srxlev and Squal, but not to Rₛ, or to apply scaling only to Rₛ, but not to Srxlev and Squal.

Section X, which is referred to in the above example text as the section where the scaling is described, describes the details of how scaling should be applied to Srxlev, Squal and/or Rₛ., wherein selected parts (different parts in different embodiments) of the following information may be included.

Because Srxlev and Squal are the measurement quantities that determine whether the UE is allowed to refrain from intra-frequency neighbor cell measurements, these measurement quantities may be subject to the scaling, i.e. negative values may be added to them in the logarithmic domain, e.g. Q_{rxlevNearEndOfServiceScalingOffset} and Q_{qualNerEndOfServiceScalingOffset}, where these are negative numbers in dB, e.g. set to respectively

$${Q}_{rxlevNearEndOfServiceScalingOffset} = 10 \times lg ( {k}_{rxlev} \times \frac{Tservice}{TserviceThresholdNTN} )$$

$${Q}_{qualNearEndOfServiceScalingOffset} = 10 \times lg ( {k}_{q u a l} \times \frac{Tservice}{TserviceThresholdNTN} )$$

wherein kᵣₓₗₑᵥ and k_{qual} are configurable (or specified) constants greater than zero. This serves to ensure that the UE performs intra-frequency neighbor cell measurements when it is in the Near-end-of-service (sub)state.

In addition, to ensure that the UE, after performing intra-frequency cell measurements, does not persist to assess that the serving cell is the best (highest ranked) so that cell reselection is suboptimally delayed, the service cell's ranking criterion/value, Rₛ, may be scaled in a similar way, e.g. by adding a negative value measured in dB, e.g. Qoffset_{NearEndOfServiceScaling}, which may be calculated as follows:

$${Qoffset}_{N e a rEndOfServiceScaling} = 10 \times lg ( {k}_{ServingCellRanking} \times \frac{Tservice}{T S erviceThresholdNTN} )$$

wherein k_{ServingCellRanking} is a configurable (or specified) constant greater than zero.

An optional alternative to the above described dynamic size of the scaling is to use fixed scaling that is applied when the condition for the Near-end-of-service state is fulfilled, e.g. to have fixed configured (or specified) values for Q_{rxlevNearEndOfServiceScalingOffset}, Q_{qualNearEndOfServiceScalingOffset} and/or Qoffset_{NearEndOfServiceScaling}.

The above described embodiments involving the Near-end-of-service (sub)state may be modified so that the new (sub)state is not introduced, but the UE still performs the described scaling triggered by the same conditions as described for the Near-end-of-service (sub)state. That is, although a new (sub)state may be a convenient and suitable way to introduce the scaling in the standard specification(s) and UE implementations, the new (sub)state is not a requirement for introduction of the above described conditional scaling.

In other embodiment variants, dynamic scaling, similar to what was described above where the relation between Tservice and TserviceThresholdNTN was the basis for the size of the scaling, may also be based on geographical relations involving the UE location (with or without the Near-end-of-service (sub)state).

For example, instead of letting a UE location based condition directly impact whether the UE is allowed to refrain from intra-frequency neighbor cell measurements, as described above, the UE location based condition may have indirect impact by triggering scaling of Srxlev, Squal and/or R s and also determine the size of the scaling. The following are some examples of this principle:

$${Q}_{rxlevScalingOffset} = 10 \times lg ( {k}_{Srxlev} \times \frac{distanceToServingCellCenterThreshold}{distanceToServingCellCenter} ) {Q}_{qualScalingOffset} = 10 \times lg ( {k}_{Squal} \times \frac{distanceToServingCellCencerThreshold}{distanceToServingCellCencer} ) {Qoffset}_{RsScaling} = 10 \times lg ( {k}_{Rs} \times \frac{distanceToServingCellCencerThreshold}{distanceToServingCellCencer} )$$

When the UE distance to the serving cell center, distanceToServingCellCenter, exceeds the threshold, distanceToServingCellCenterThreshold, the UE scales Srxlev, Squal and/or Rₛ by adding dB values in the logarithmic domain, e.g. Q_{rxlevScalingOffset}, Q_{qualScalingOffset} and/or Qoffset_{RsScaling}, for respectively Srxlev, Squal and Rₛ, where these values are calculated as follows:
where k_{Srxlev}, k_{Squal} and k_{Rs} are configurable (or specified) constants greater than zero.

$${Q}_{rxlevScalingOffset} = 10 \times lg ( \frac{{k}_{Srxlev}}{distanceFromNoMeasurementZone + {k}_{Srxlev}} ) {Q}_{qualscalingOffset} = 10 \times lg ( \frac{{k}_{Squal}}{distanceFromNoMeasurementZone + {k}_{Squal}} ) {Qoffset}_{RsScaling} = 10 \times lg ( \frac{{k}_{R s}}{distanceFromNoMeasurementZone + {k}_{R s}} )$$

When the UE is outside its configured no-measurement zone, the UE scales Srxlev, Squal and/or Rₛ by adding dB values in the logarithmic domain, e.g. Q_{rxlevScalingOffset}, Q_{qualScalingOffset} and/or Qoffset_{RsScaling}, for respectively Srxlev, Squal and Rₛ, where these values are calculated as follows:
where k_{Srxlev}, k_{Squal} and k_{Rs} are configurable (or specified) constants greater than zero and distanceFromMeasurementZone is the UE distance from the border of the configured (or specified) no-measurement zone.

$${Q}_{rxlevScalingOffset} = 10 \times lg ( \frac{{k}_{Srxlev}}{distanceFromServingCellEdge + {k}_{Srxlev}} ) {Q}_{qualScalingOffset} = 10 \times lg ( \frac{{k}_{Squal}}{distanceFromServingCellEdge + {k}_{Squal}} ) {Qoffset}_{RsScaling} = 10 \times lg ( \frac{{k}_{R s}}{distanceFromServingCellEdge + {k}_{R s}} )$$

When the UE is outside a configured estimated coverage area of the serving cell, the UE scales Srxlev, Squal and/or Rₛ by adding dB values in the logarithmic domain, e.g. Q_{rxlevScalingOffset}, Q_{qualScalingOffset} and/or Qoffset_{RsScaling}, for respectively Srxlev, Squal and Rₛ, where these values are calculated as follows:
where k_{Srxlev}, k_{Squal} and k_{Rs} are configurable (or specified) constants greater than zero and distanceFromServingCellEdge is the UE distance from the border of the configured (or specified) estimated coverage area of the serving cell.

$${Q}_{rxlevScalingOffset} = 10 \times lg ( \frac{{k}_{Srxlev}}{{k}_{Srxlev + cellCenterDistanceDifferenceThreshold + D}} ) {Q}_{qualScalingOffset} = 10 \times lg ( \frac{{k}_{Squal}}{{k}_{Squal + cellCenterDistanceDifferenceThreshold + D}} ) {Qoffset}_{RsScaling} = 10 \times lg ( \frac{{k}_{R s}}{{k}_{Rs + cellCenterDistanceDifferenceThreshold + D}} )$$

When the UE distance to the closest center of another cell other than the serving cell is smaller than the UE distance to the center of the serving cell, or the UE distance to the center of the serving cell is smaller than the distance to the closest cell center of any other cell, but the difference between the UE distance to the closest center of a non-serving cell (i.e., another cell other than the serving cell) and the UE distance to the center of the serving cell is smaller than the threshold cellCenterDistanceDifferenceThreshold, the UE scales Srxlev, Squal and/or Rₛ by adding dB values in the logarithmic domain, e.g. Q_{rxlevScalingOffset}, Q_{qualScalingOffset} and/or Qoffset_{RsScaling}, for respectively Srxlev, Squal and Rₛ, where these values are calculated as follows:
where k_{Srxlev}, k_{Squal} and k_{Rs} are configurable (or specified) constants greater than zero and D=distanceToServingCellCenter−distanceToClosestNonServingCellCenter, where distanceToClosestServingCellCenter is the UE distance to the closest center point of a cell other than the serving cell.

In some embodiments, scaling is applied without a condition that triggers it (i.e., scaling is always applied). In this embodiment, the scaling is applied to the ranking criterion/value for the serving cell, Rₛ, as well as to the ranking criterion/value for each of the neighbor cell(s) participating in the ranking, Rₙ. The scaling is based on the UE distance to the center of the concerned cell and may consist of addition of a dB value in the logarithmic domain, e.g. Qoffset_{RsScaling} and Qoffset_{RnScaling}, where these values may be calculated as follows:

$${Qoffset}_{RsScaling} = 10 \times lg ( \frac{{k}_{R s}}{{k}_{R s} + distanceToServingCellCenter} )$$

$${Qoffset}_{RnScaling} = 10 \times lg ( \frac{{k}_{R n}}{{k}_{R n} + distanceToNeighborCellCenter} )$$

where k_{Rs} and k_{Rn} are configurable (or specified) constants greater than zero, distanceToServingCellCenter is the UE distance to the center of the serving cell and distanceToNeighborCellCenter is the UE distance to the center of the concerned neighbor cell. The constants k_{Rs} and k_{Rn} may be configured (or specified) to be equal, i.e. k_{Rs}=k_{Rn}, to provide equivalent scaling conditions for the serving and the neighbor cells. Another option is to configure (or specify) k_{Rs}>k_{Rn} to favor remaining in the serving cell unless a neighbor cell is significantly better.

As a further option for moving cells, the movement direction of the center of the cell in relation to the UE (i.e., in practice a result of the movement of the concerned cell and the movement of the UE) may also impact the scaling. For example, a positive dB offset, Qoffset_{MovingCloser}, may be added to the ranking criterion/value, Rₛ and Rₙ, if the cell center is moving in a direction that takes it closer to the UE, and a negative dB offset, Qoffset_{MovingFurtherAway}, may be added to the ranking criterion/value, Rₛ or Rₙ, if the cell center is moving in a direction that takes it further away from the UE. As yet another option, no movement direction based offset is added to the ranking criterion/value, Rₛ or Rₙ, if the movement direction of the cell center neither takes the cell center significantly closer to the UE nor significantly further away from the UE (i.e., the cell center is essentially passing by the UE location).

As another embodiment, when a UE ranks the cells that are subject to the cell reselection evaluation procedure, i.e. the serving cell and neighbor cells that are candidates for cell reselection, the UE checks the rules for Tservice such that an NTN cell is removed from ranking if its Tservice is too small. In another embodiment, when a UE ranks the cells that are subject to the cell reselection evaluation procedure, i.e. the serving cell and neighbor cells that are candidates for cell reselection, the UE checks the rules for Tservice and UE location such that an NTN cell is removed from ranking if its Tservice is too small or if the UE distance to the center of the cell is too large. In yet another embodiment, when a UE ranks the cells that are subject to the cell reselection evaluation procedure, i.e. the serving cell and neighbor cells that are candidates for cell reselection, the UE checks the rules for UE location such that an NTN cell is removed from ranking if the UE distance to the center of the cell is too large.

As another embodiment, the cell ranking procedure (involving the serving cell and neighbor cell that may be candidates for cell reselection) may be seen as a procedure with multiple steps, as follows.

First, the UE identifies the cells that satisfy the cell selection criterion S (see section 5.2.3.2 in 3GPP TS 38.304).

Second, for the cells identified in the first step, the UE checks whether they fulfil the Tservice and/or UE location-based condition. The conditions may be any of the conditions previously elaborated that may be applicable, e.g. that Tservice>TserviceThresholdNTN or that the UE distance to the center of the cell does not exceed a configured threshold or a combination of these conditions. If a cell does not fulfil the condition, it is excluded from the further ranking procedure. These cells, if any, are referred to as the excluded cells.

Third, the remaining cells are ranked according to the legacy ranking procedure (i.e., based on the ranking criteria/values, Rₛ and Rₙ, as described in section 5.2.4.6 in 3GPP TS 38.304). (As other variants, scaling of Rₛ and Rₙ may also be applied in this step, e.g. as described above based on the UE distance to the cell center and possibly based on the cell movement direction.)

Fourth, if the parameter rangeToBestCell is configured, any non-highest ranked cell whose ranking value, Rₙ or Rₛ, is closer to the highest R value than rangeToBestCell, are qualified to a second round, where the UE selects the cell to reselect to (or remain camping on, in case the serving cell is selected) based on their degree of fulfilment of the condition evaluated in the second step. For example, if the condition is based on Tservice, the candidate cell with the longest Tservice is selected. As another example, if the condition is based on the UE distance to the cell center, the candidate cell for which the UE distance to the cell center is the shortest is selected.

If there are no cells remaining after the second step where cells that do not fulfil the Tservice based or UE location based condition are excluded (i.e., none of the cells fulfilled the condition), the one of the excluded cells that is closest to fulfilling the condition is selected.

In legacy cell reselection and cell ranking, the rangeToBestCell parameter is not used to distinguish cells based on Tservice or a UE location based condition, but to distinguish among the cells with more or less equivalent channel quality based on the number of good beams (i.e., the number of beams for which the channel quality is sufficiently good). This legacy use of the rangeToBestCell parameter may be combined with the use described in step four above. To this end, if in step four above, there is one or more cell(s) with a Tservice that is closer to the Tservice of the best cell (i.e., the longest Tservice identified in step four) than a configured (or specified) parameter TserviceRangeToBestCell, these cells are considered as equivalent with the cell with the longest Tservice and the one of these cells with the greatest number of good beams is selected.

Similarly, if the cells in step four are distinguished based on the UE distance to the cell center, then if in step four above, there is one or more cell(s) for which the UE distance to the cell center is closer to the UE distance to the cell center for the best cell (i.e., the shortest distance to the cell center identified in step four) than a configured (or specified) parameter distanceToCellCenterRangeToBestCell, these are considered as equivalent with the cell for which the UE distance to the cell center is the shortest and the one of these cells with the greatest number of good beams is selected.

Another way to combine the legacy use of the rangeToBestCell parameter with step four above is to first apply the legacy use and if this results in a set of beams with an equal number of good beams, then the Tservice or UE location based condition is used to select one of the cells.

If in any of these embodiment variants, no single cell is unambiguously selected after applying all rules, conditions and criteria, the UE (based on UE implementation) may select any of the equivalent best cell for cell reselection (or for remaining in the serving cell if the serving cell is selected).

Below is an example of how one of these embodiment variants may be realized in section 5.2.4.6 in 3GPP TS 38.304. The illustrated example embodiment is the one where Tservice>TserviceThresholdNTN is the condition to be fulfilled for a cell to avoid exclusion and Tservice is the distinguishing parameter among the cells satisfying the rangeToBestCell condition. Note that other examples for a modified specification text for where the distance to the cell center is used instead of Tservice and/or where the use of Tservice/cell center distance with rangeToBestCell is combined with the number of good beams criterion may be deduced. The modified specification text (which is the major part of the text in section 5.2.4.6 in TS 38.304) is as follows:

### Start of Modified Specification Text

The cell-ranking criterion Rₛ for serving cell and Rₙ for neighbouring cells is defined by:

Rₛ=Q_{meas,s}+Q_{hyst}−Qoffsetₜₑₘₚ

Rₙ=Q_{meas,n}−Qoffset−Qoffsetₜₑₘₚ

where:

| Qₘₑₐₛ | RSRP measurement quantity used in cell |
|---|---|
| | reselections. |
| Qoffset | For intra-frequency: Equals to Qoffset_{s,n}, if Qoffset_{s,n} |
| | is valid, otherwise this equals to zero. |
| | For inter-frequency: Equals to Qoffset_{s,n} plus |
| | Qoffset_{frequency}, if Qoffset_{s,n} is valid, otherwise this |
| | equals to Qoffset_{frequency}. |
| Qoffsetₜₑₘₚ | Offset temporarily applied to a cell as specified in TS |
| | 38.331. |

The UE shall perform ranking of all cells that fulfil the cell selection criterion S, which is defined in 5.2.3.2, and which are not excluded based on the Tservice condition. Cells that fulfil the cell selection criterion S, but for which the Tservice is below TserviceThresholdNTN are excluded from the cell ranking.

The remaining cells shall be ranked according to the R criteria specified above by deriving Q_{meas,n} and Q_{meas,s} and calculating the R values using averaged RSRP results.

If rangeToBestCell is not configured, the UE shall perform cell reselection to the highest ranked cell. If this cell is found to be not-suitable, the UE shall behave according to clause 5.2.4.4.

If rangeToBestCell is configured, then the UE shall perform cell reselection to the cell with the longest Tservice among the cells whose R value is within rangeToBestCell of the R value of the highest ranked cell. If multiple such cells have the same longest Tservice, the UE shall perform cell reselection to the highest ranked cell among them. If this cell is found to be not-suitable, the UE shall behave according to clause 5.2.4.4.

### End of Modified Specification Text

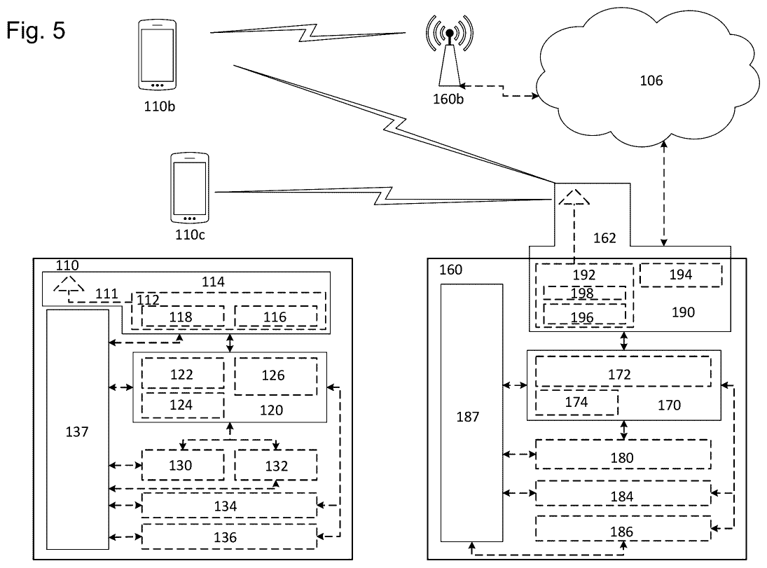

FIG. 5 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 5, network node 160 includes processing circuitry 170, device readable medium 180, interface 190, auxiliary equipment 184, power source 186, power circuitry 187, and antenna 162. Although network node 160 illustrated in the example wireless network of FIG. 5 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 5 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 5. For simplicity, the wireless network of FIG. 5 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

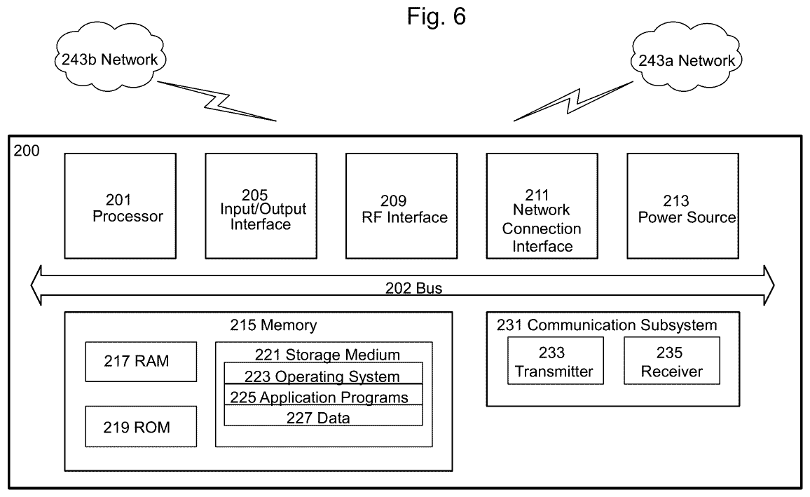

FIG. 6 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 6, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 6 is a UE, the components discussed herein are equally applicable to a WD, and vice-versa.

In FIG. 6, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 6, or only a subset of the components. The level of integration between the components may vary from one UE to another UE. Further, certain UEs may contain multiple instances of a component, such as multiple processors, memories, transceivers, transmitters, receivers, etc.

In FIG. 6, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 6, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243 a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 6, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

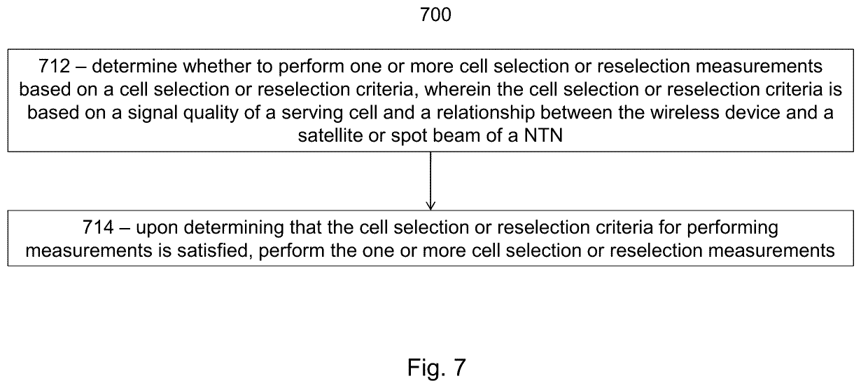

FIG. 7 is a flowchart illustrating an example method in a wireless device, according to certain embodiments. In particular embodiments, one or more steps of FIG. 7 may be performed by wireless device 110 described with respect to FIG. 5.

The method may begin at step 712, where the wireless device (e.g., wireless device 110) determines whether to perform one or more cell selection or reselection measurements based on a cell selection or reselection criteria. The cell selection or reselection criteria is based on a signal quality of a serving cell and a relationship between the wireless device and a satellite or spot beam of the NTN.

In particular embodiments, the relationship between the wireless device and the satellite or spot beam comprises a remaining service time (Tservice) associated with the satellite or spot beam. Determining that the cell selection or reselection criteria for performing measurements is satisfied may comprise determining that Tservice is below a threshold remaining service time value (regardless of the signal quality of the serving cell). Determining that the cell selection or reselection criteria for performing measurements is not satisfied may comprise determining that Tservice is above a threshold remaining service time value (regardless of the signal quality of the serving cell).

In particular embodiments, the threshold remaining service time equals an amount of coexistence time between two satellites or spot beams.

In particular embodiments, the relationship between the wireless device and the satellite or spot beam comprises a location of the wireless device. Determining whether the cell selection or reselection criteria for performing measurements is satisfied may comprise determining whether the wireless device is located within a designated coverage area, determining whether the wireless device is located within a threshold distance of a center of the serving cell, determining whether the wireless device is located within a threshold distance of an edge of the serving cell, determining whether the wireless device is located within a threshold distance of a center of a neighbor cell, and/or determining a direction of movement of the wireless device with respect to a direction of movement of the satellite or spot beam.

In particular embodiments, thresholds for evaluating a signal quality of a serving cell are scaled based on the relationship between the wireless device and the satellite or spot beam.

In particular embodiments, the wireless device determines whether to perform measurements according to any of the embodiments and examples described herein.

At step 714, upon determining that the cell selection or reselection criteria for performing measurements is satisfied, the wireless device performs the one or more cell selection or reselection measurements.

Modifications, additions, or omissions may be made to method 700 of FIG. 7. Additionally, one or more steps in the method of FIG. 7 may be performed in parallel or in any suitable order.

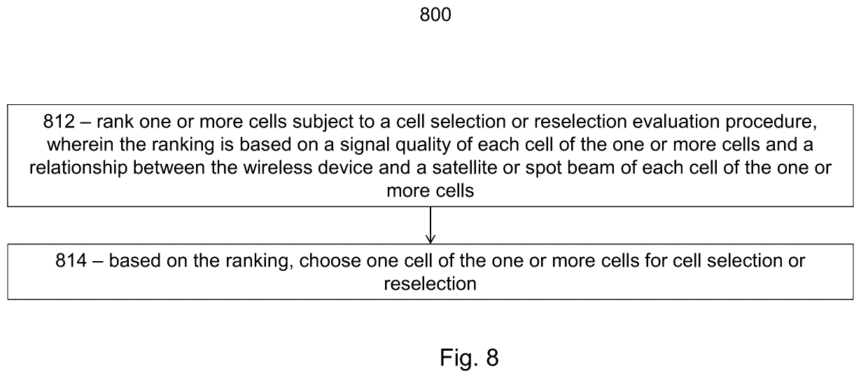

FIG. 8 is a flowchart illustrating another example method in a wireless device, according to certain embodiments. In particular embodiments, one or more steps of FIG. 8 may be performed by wireless device 110 described with respect to FIG. 5.

The method may begin at step 812, where the wireless device (e.g., wireless device 110) ranks one or more cells subject to a cell selection or reselection evaluation procedure. The ranking is based on a signal quality of each cell of the one or more cells and a relationship between the wireless device and a satellite or spot beam of each cell of the one or more cells.

In particular embodiments, the relationship between the wireless device and the satellite or spot beam comprises a remaining service time (Tservice) associated with the satellite or spot beam.

In particular embodiments, ranking the one or more cells comprises determining whether Tservice is below a threshold remaining service time value. The threshold remaining service time may equal an amount of coexistence time between two satellites or spot beams.

In particular embodiments, the relationship between the wireless device and the satellite or spot beam comprises a location of the wireless device. Ranking the one or more cells may comprise determining whether the wireless device is located within a designated coverage area, determining whether the wireless device is located within a threshold distance of a center the cell, determining whether the wireless device is located within a threshold distance of an edge of the cell, and/or determining a direction of movement of the wireless device with respect to a direction of movement of the satellite or spot beam.

In particular embodiments, thresholds for evaluating a signal quality of a cell of the one or more cells are scaled based on the relationship between the wireless device and the satellite or spot beam.

In particular embodiments, the wireless device ranks one or more cells according to any of the embodiments and examples described herein.

At step 814, based on the ranking, the the wireless device chooses one cell of the one or more cells for cell selection or reselection.

Modifications, additions, or omissions may be made to method 800 of FIG. 8. Additionally, one or more steps in the method of FIG. 8 may be performed in parallel or in any suitable order.

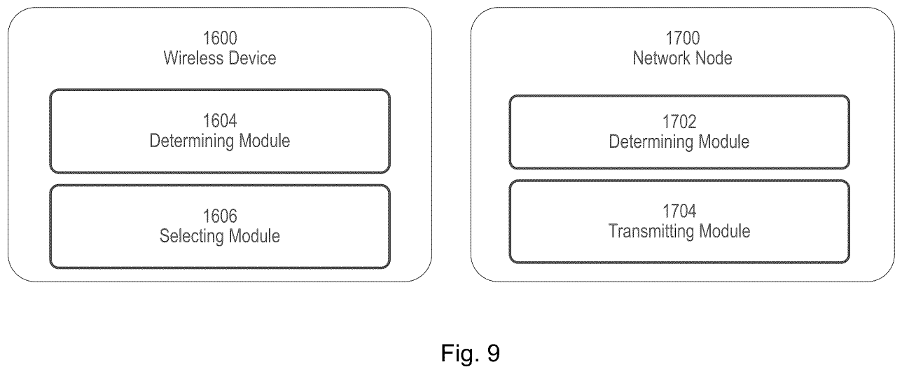

FIG. 9 illustrates a schematic block diagram of two apparatuses in a wireless network (for example, the wireless network illustrated in FIG. 5). The apparatuses include a wireless device and a network node (e.g., wireless device 110 and network node 160 illustrated in FIG. 5). Apparatus 1600 is operable to carry out the example methods described with reference to FIGS. 7 and 8, and possibly any other processes or methods disclosed herein. It is also to be understood that the methods of FIGS. 7 and 8 are not necessarily carried out solely by apparatus 1600. At least some operations of the methods can be performed by one or more other entities.

Virtual apparatuses 1600 and 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause determining module 1604, selecting module 1606, and any other suitable units of apparatus 1600 to perform corresponding functions according one or more embodiments of the present disclosure. Similarly, the processing circuitry described above may be used to cause determining module 1702, transmitting module 1704, and any other suitable units of apparatus 1700 to perform corresponding functions according one or more embodiments of the present disclosure.

As illustrated in FIG. 9, apparatus 1600 includes determining module 1604 configured to determine whether to perform measurements and cell ranking according to any of the embodiments and examples described herein. Selecting module 1606 is configured to perform cell selection or reselection, according to any of the embodiments and examples described herein.

As illustrated in FIG. 9, apparatus 1700 includes determining module 1702 configured to determine cell selection or reselection configuration parameters according to any of the embodiments and examples described herein. Transmitting module 1704 is configured to transmit the configuration parameters to a wireless device according to any of the embodiments and examples described herein.

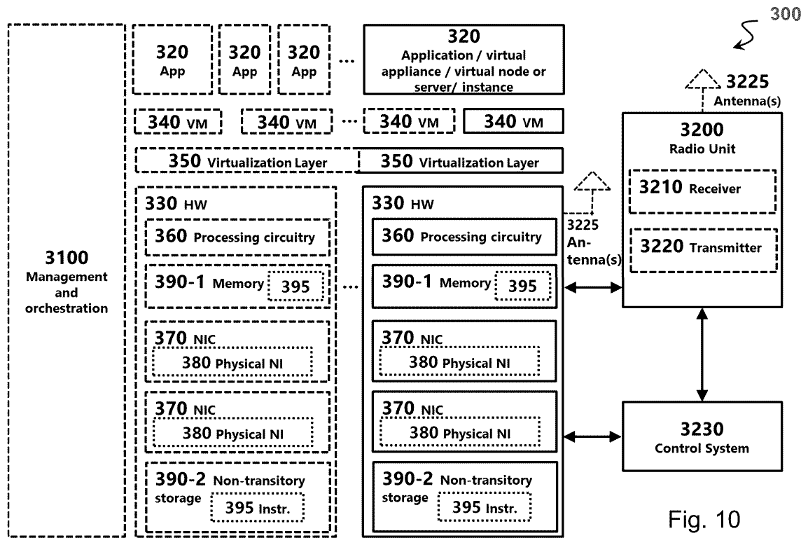

FIG. 10 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 10, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 18.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

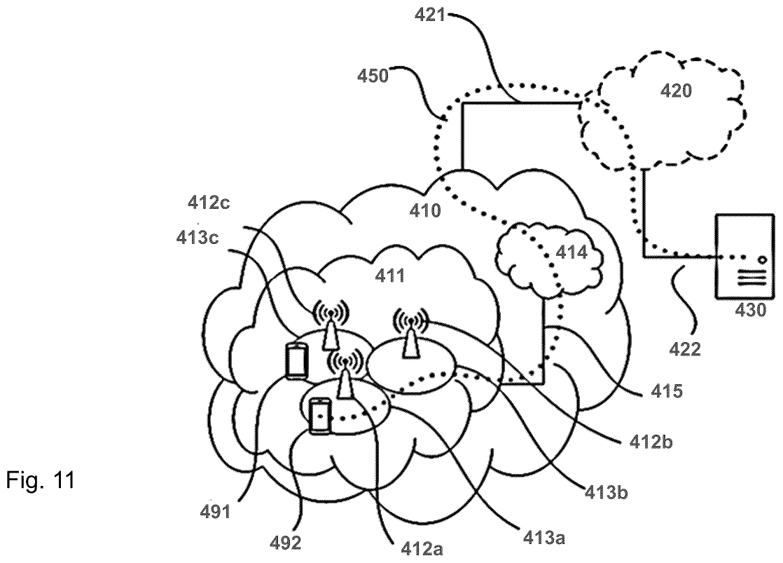

With reference to FIG. 11, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NB s, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 11 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

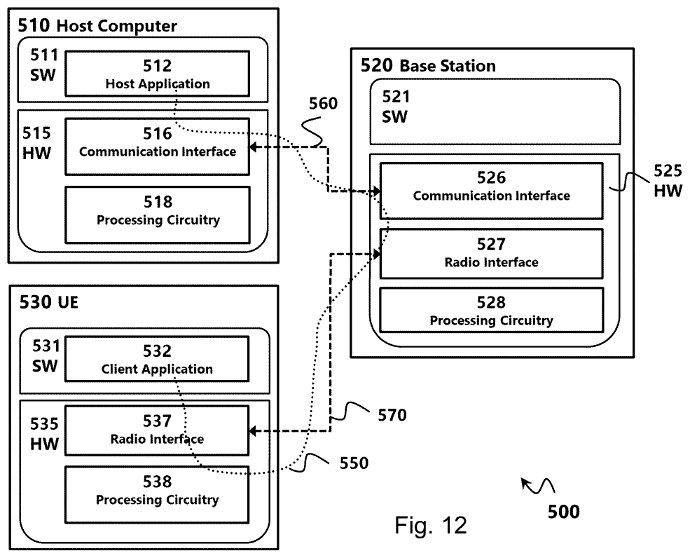

FIG. 12 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 12. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 12) served by base station 520. Communication interface 526 may be configured to facilitate connection 560 to host computer 510. Connection 560 may be direct, or it may pass through a core network (not shown in FIG. 12) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 12 may be similar or identical to host computer 430, one of base stations 412a, 412b, 412c and one of UEs 491, 492 of FIG. 10, respectively. This is to say, the inner workings of these entities may be as shown in FIG. 12 and independently, the surrounding network topology may be that of FIG. 10.

In FIG. 12, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, which may provide faster internet access for users.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

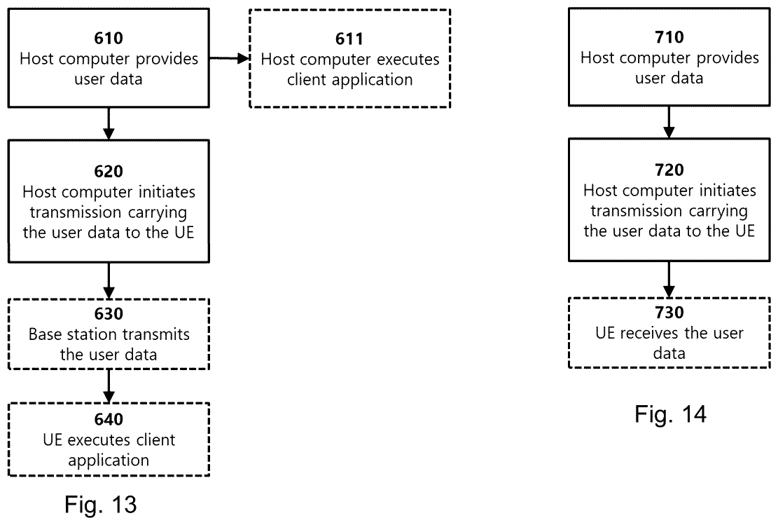

FIG. 13 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 13 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 14 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 14 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

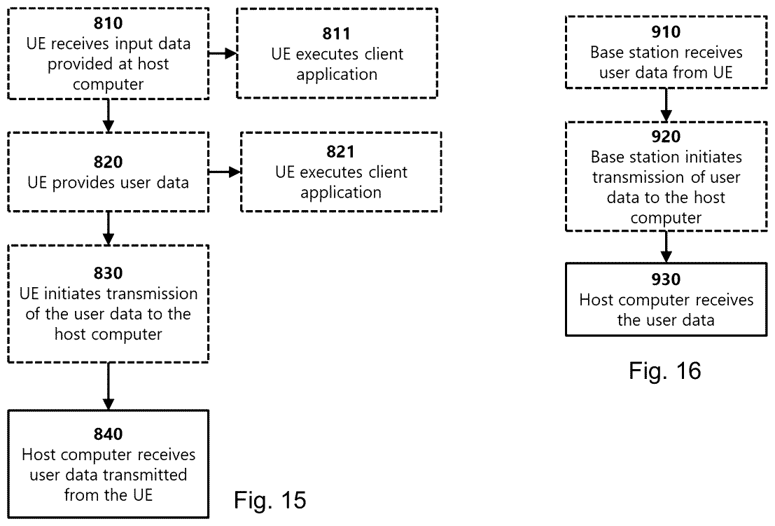

FIG. 15 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 15 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 16 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a wireless device for cell selection or reselection in a non-terrestrial network (NTN), the method comprising:
determining whether to perform one or more cell selection or reselection measurements based on a cell selection or reselection criteria, wherein the cell selection or reselection criteria is based on a signal quality of a serving cell and a relationship between the wireless device and a satellite or spot beam of the NTN;
upon determining that the cell selection or reselection criteria for performing measurements is satisfied, performing the one or more cell selection or reselection measurements.

2-14. (canceled)

15. A wireless device capable of performing cell selection or reselection in a non-terrestrial network (NTN), the wireless device comprising processing circuitry operable to:
determine whether to perform one or more cell selection or reselection measurements based on a cell selection or reselection criteria, wherein the cell selection or reselection criteria is based on a signal quality of a serving cell and a relationship between the wireless device and a satellite or spot beam of the NTN;
upon determining that the cell selection or reselection criteria for performing measurements is satisfied, perform the one or more cell selection or reselection measurements.

16. The wireless device of claim 15, wherein the relationship between the wireless device and the satellite or spot beam comprises a remaining service time (Tservice) associated with the satellite or spot beam.

17. The wireless device of claim 16, wherein the processing circuitry is operable to determine that the cell selection or reselection criteria for performing measurements is satisfied by determining that Tservice is below a threshold remaining service time value.

18. The wireless device of claim 16, wherein the processing circuitry is operable to determine that the cell selection or reselection criteria for performing measurements is satisfied by determining that Tservice is below a threshold remaining service time value regardless of the signal quality of the serving cell.

19. The wireless device of claim 16, wherein the processing circuitry is operable to determine that the cell selection or reselection criteria for performing measurements is not satisfied by determining that Tservice is above a threshold remaining service time value.

20. The wireless device of claim 16, wherein the processing circuitry is operable to determine that the cell selection or reselection criteria for performing measurements is not satisfied by determining that Tservice is above a threshold remaining service time value regardless of the signal quality of the serving cell.

21. The wireless device of claim 16, wherein the threshold remaining service time equals an amount of coexistence time between two satellites or spot beams.

22. The wireless device of claim 15, wherein the relationship between the wireless device and the satellite or spot beam comprises a location of the wireless device.

23. The wireless device of claim 22, wherein the processing circuitry is operable to determine whether the cell selection or reselection criteria for performing measurements is satisfied by determining whether the wireless device is located within a designated coverage area.

24. The wireless device of claim 22, wherein the processing circuitry is operable to determine whether the cell selection or reselection criteria for performing measurements is satisfied by determining whether the wireless device is located within a threshold distance of a center of the serving cell.

25. The wireless device of claim 22, wherein the processing circuitry is operable to determine whether the cell selection or reselection criteria for performing measurements is satisfied by determining whether the wireless device is located within a threshold distance of an edge of the serving cell.

26. The wireless device of claim 22, wherein the processing circuitry is operable to determine whether the cell selection or reselection criteria for performing measurements is satisfied by determining whether the wireless device is located within a threshold distance of a center of a neighbor cell.

27. The wireless device of claim 22, wherein the processing circuitry is operable to determine whether the cell selection or reselection criteria for performing measurements is satisfied by determining a direction of movement of the wireless device with respect to a direction of movement of the satellite or spot beam.

28. The wireless device of claim 15, wherein thresholds for evaluating a signal quality of a serving cell are scaled based on the relationship between the wireless device and the satellite or spot beam.

29. A method performed by a wireless device for cell selection or reselection in a non-terrestrial network (NTN), the method comprising:
ranking one or more cells subject to a cell selection or reselection evaluation procedure, wherein the ranking is based on a signal quality of each cell of the one or more cells and a relationship between the wireless device and a satellite or spot beam of each cell of the one or more cells;
based on the ranking, choosing one cell of the one or more cells for cell selection or reselection.

30-38. (canceled)

39. A wireless device capable of performing cell selection or reselection in a non-terrestrial network (NTN), the wireless device comprising processing circuitry operable to:
rank one or more cells subject to a cell selection or reselection evaluation procedure, wherein the ranking is based on a signal quality of each cell of the one or more cells and a relationship between the wireless device and a satellite or spot beam of each cell of the one or more cells;
based on the ranking, choose one cell of the one or more cells for cell selection or reselection.

40. The wireless device of claim 39, wherein the relationship between the wireless device and the satellite or spot beam comprises a remaining service time (Tservice) associated with the satellite or spot beam.

41. The wireless device of claim 40, wherein the processing circuitry is operable to rank the one or more cells by determining whether Tservice is below a threshold remaining service time value.

42. The wireless device of claim 40, wherein the threshold remaining service time equals an amount of coexistence time between two satellites or spot beams.

43. The wireless device of claim 39, wherein the relationship between the wireless device and the satellite or spot beam comprises a location of the wireless device.

44. The wireless device of claim 43, wherein the processing circuitry is operable to rank the one or more cells by determining whether the wireless device is located within a designated coverage area.

45. The wireless device of claim 43, wherein the processing circuitry is operable to rank the one or more cells by determining whether the wireless device is located within a threshold distance of a center the cell.

46. The wireless device of claim 43, wherein the processing circuitry is operable to rank the one or more cells by determining whether the wireless device is located within a threshold distance of an edge of the cell.

47. The wireless device of claim 43, wherein the processing circuitry is operable to rank the one or more cells by determining a direction of movement of the wireless device with respect to a direction of movement of the satellite or spot beam.

48. The wireless device of claim 39, wherein thresholds for evaluating a signal quality of a cell of the one or more cells are scaled based on the relationship between the wireless device and the satellite or spot beam.
